(19) United States
(12) Patent Application Publication
(10) Pub. No.: US 2022/0266180 A1
(43) Pub. Date: Aug. 25, 2022

(54) Spunbonded Air-Filtration Web

(71) Applicant: 3M INNOVATIVE PROPERTIES COMPANY, St. Paul, MN (US)

(72) Inventors: John D. Stelter, Osceola, WI (US); Zachary J. Becker, Minneapolis, MN (US); Michael R. Berrigan, Oakdale, MN (US); Alexander P. Flage, Woodbury, MN (US); Andrew R. Fox, Oakdale, MN (US); Bryan L. Gerhardt, Woodbury, MN (US); Himanshu Jasuja, Woodbury, MN (US); William J. Kopecky, Hudson, WI (US); Patrick J. Sager, Hastings, MN (US); Samatha D Smith, Minneapolis, MN (US); Jacob J. Thelen, Minneapois, MN (US); Kent B. Willgohs, Farmington, MN (US)

(21) Appl. No.: 17/628,683

(22) PCT Filed: Aug. 12, 2020
(86) PCT No.: PCT/IB2020/057599

§ 371 Date: Jan. 20, 2022

Related U.S. Application Data
(60) Provisional application No. 62/886,129, filed on Aug. 13, 2019.

(51) Int. Cl. B01D 39/16; D04H 3/16; D04H 3/14

(52) U.S. Cl. CPC B01D 39/163; D04H 3/16; D04H 3/14; B01D 2239/0435; B01D 2239/1233; B01D 2239/0622

(57) ABSTRACT

A single-layer spunbonded air-filtration web including meltspun autogenously bonded electret fibers with an Actual Fiber Diameter of from 3.0 microns to 15 microns. The air-filtration web exhibits a ratio of mean flow pore size to pore size range of from 0.55 to 2.5. Also disclosed are methods of making such webs, and methods of using such webs to perform air filtration.

### BACKGROUND

Spunbonded webs have found use in various applications, including backings for diapers and/or personal care articles, carpet backings, geotextiles and the like. Such spunbonded webs are often relied upon e.g. to supply structural reinforcement, barrier properties, and so on.

### SUMMARY

In broad summary, herein are disclosed spunbonded air-filtration webs comprising meltspun autogenously bonded electret fibers with an Actual Fiber Diameter of from 3.0 microns to 15 microns. The air-filtration webs exhibit a ratio of mean flow pore size to pore size range of from 0.55 to 2.5. Also disclosed are methods of making such webs, and methods of using such webs to perform air filtration. These and other aspects of the invention will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a schematic diagram of an exemplary apparatus which may be used to form a spunbonded air-filtration web as disclosed herein.

FIG. 2 is a side view of an exemplary attenuator which may be used in the apparatus of FIG. 1.

FIG. 3 is a side view of an exemplary air-delivery device that can be used to deliver quenching air to a filament stream.

FIG. 4 is a perspective view, partially in section, of a pleated filter with a perimeter frame and a scrim.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties unless otherwise specifically defined). It will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match.

Those of ordinary skill will appreciate that as used herein, terms such as “essentially free of”, and the like, do not preclude the presence of some extremely low (e.g. less than 0.1 wt. %) amount of material, as may occur e.g. when using large scale production equipment subject to customary cleaning procedures. The term “configured to” and like terms is at least as restrictive as the term “adapted to”, and requires actual design intention to perform the specified function rather than mere physical capability of performing such a function. All references herein to numerical values (e.g. dimensions, ratios, and so on), unless otherwise noted, are understood to be calculable as average values derived from an appropriate number of measurements of the parameter(s) in question.

### DETAILED DESCRIPTION

### Glossary

The term “filaments” is used in general to designate molten streams of thermoplastic material that are extruded from a set of orifices, and the term “fibers” is used in general to designate solidified filaments and webs comprised thereof. These designations are used for convenience of description only. In processes as described herein, there may be no firm dividing line between partially solidified filaments, and fibers which still comprise a slightly soft, tacky, and/or semi-molten surface.

The term “meltspun” refers to fibers that are formed by extruding filaments out of a set of orifices and allowing the filaments to cool and solidify to form fibers, with the filaments passing through a space containing streams of moving air to assist in cooling (e.g. quenching) the filaments and then passing through an attenuation unit to at least partially draw the filaments. Meltspinning can be distinguished from meltblowing in that meltblowing involves the extrusion of filaments into converging high velocity air streams introduced by way of air-blowing orifices located in close proximity to the extrusion orifices. Meltspun fibers, and meltspun webs, can thus be distinguished from meltblown fibers and webs and also from e.g. electrospun fibers and webs, as will be well understood by those skilled in the art of nonwoven web formation.

By “spunbonded” is meant a nonwoven web comprising a set of meltspun fibers collected as a fibrous mass and subjected to one or more bonding operations to bond at least some fibers to other fibers.

By “autogenously bonded” is meant a nonwoven web bonded by a bonding operation that involves exposure to elevated temperature without the application of solid contact pressure onto the web.

By “pleated” is meant an air-filtration web at least portions of which have been folded to form a configuration comprising rows of generally parallel, oppositely oriented folds.

By an “air-filtration” web is meant a nonwoven fibrous web that is configured to filter particulates from a stream of moving air. Often, an air-filtration web will comprise electret fibers.

Disclosed herein is a spunbonded nonwoven air-filtration web comprising meltspun electret fibers. By an air-filtration web is meant a fibrous web that is configured to capture at least particulate matter from a stream of air passing through the fibrous web. By definition, an air-filtration web (or, in general, an air-filtration layer) will exhibit a Quality Factor (when tested with NaCl at 32 liters per minute (LPM), as discussed later herein) of at least 0.15. Meltspun electret fibers will be readily recognizable to ordinary artisans; method of providing meltspun and electret fibers are described later herein. In various embodiments, the meltspun electret fibers may make up (by number) at least 90, 95, 98, 99, or essentially 100% of the fibers of the spunbonded nonwoven air-filtration web. Thus in some embodiments the meltspun electret fibers may be the only fibers present in the web (for example, such a web may be free of meltblown fibers).

The meltspun electret fibers of the web exhibit an Actual Fiber Diameter of from 3.0 microns to 15 microns. As noted in the Test Methods of the Working Examples, the Actual Fiber Diameter is a collective (average) property of the population of fibers of the web. In various embodiments, the meltspun electret fibers may exhibit an Actual Fiber Diameter of at least 4, 6, 8, or 10 microns. In further embodiments, the meltspun electret fibers may exhibit an Actual Fiber Diameter of at most 13, 11, 9, or 7 microns.

### Pore Size Characterization

The present work has revealed the structural, geometric and/or functional characteristics of a spunbonded air-filtration web can be characterized by properties of the interstitial spaces (pores) of the web (rather than, for example, being governed solely by properties of the fibers themselves). In other words, it has been found that the way that the fibers are arranged (and thus, the character of the interstitial spaces between the fibers) plays an important role in determining the filtration performance of the web (rather than the filtration performance being determined only by e.g. the fiber diameter).

Accordingly, a spunbonded air-filtration web as disclosed herein can be characterized, and distinguished from spunbonded air-filtration webs of the art, by various parameters having to do with pore size, considered both alone and in various combinations. For example, such webs can be characterized by the mean flow pore size of the web, measured according to the procedures presented in the Test Methods of the Working Examples. In many embodiments, a herein-disclosed spunbonded air-filtration web may exhibit a mean flow pore size of from 8 to 30 microns. An air-filtration web can also be characterized by the largest measured pore size (often referred to as the “bubble point” of the web), by the smallest measured pore size, and by the pore size range (the difference between the largest and smallest pore size). The mean flow pore size will by definition fall within the pore size range.

The present work has revealed that the ratio of the mean flow pore size to the pore size range serves as a particularly useful figure of merit to characterize a spunbonded air-filtration web. (By way of a specific example, a web that exhibits a mean flow pore size of 20, a largest pore size of 34, and a smallest pore size of 10, will exhibit a ratio of 20/(34−10) or 0.83.) A mean flow pore size/pore size range ratio that is greater than 0.55 has been found to be indicative of a pore arrangement that provides enhanced air-filtration, as attested to in the Working Examples herein.

Those of ordinary skill in the art will appreciate that the mean flow pore size/pore size range ratio will affected by the absolute value of the mean flow pore size, by the absolute value of the sizes of the largest pores and of the smallest pores, by the value of the pore size range (that is, the total breadth of the pore size distribution); and, by any skewness of the pore size distribution (that is, the degree to which the mean flow pore size may be skewed toward the smallest pore size or toward the largest pore size). This ratio thus differs from, for example, parameters that are measures of only skewness, of only absolute pore size, or of only the breadth of the pore size distribution. Without wishing to be constrained by theory or mechanism, it is postulated that all of the factors underlying the above-described ratio may play at least some role in achieving the enhanced air filtration demonstrated by the herein-disclosed webs.

In various embodiments, a spunbonded air-filtration web as disclosed herein may exhibit a mean flow pore size of at least 10, 12, 14, 16, 18, or 20 microns. In further embodiments, the web may exhibit a mean flow pore size of at most 25, 23, 21, 19, 17, 15 or 13 microns. In various embodiments, an air-filtration web as disclosed herein may exhibit a largest pore size (bubble point) that is less than 60, 55, 50, or 45 microns. In further embodiments, the web may exhibit a largest pore size that is greater than 15, 20, 25, 30, or 35 microns. In various embodiments, an air-filtration web as disclosed herein may exhibit a smallest pore size that is less than 25, 20, 15, 12, or 10 microns. In further embodiments, the web may exhibit a smallest pore size that is greater than 5, 7, 9, 11, 13, 15, or 17 microns. In various embodiments, an air-filtration web as disclosed herein may exhibit a pore size range that is at least 12, 14, 16, 20, or 24 microns. In further embodiments, the web may exhibit a pore size range that is at most 35, 33, 29, 23, 19, or 15 microns.

In various embodiments, a spunbonded air-filtration web as disclosed herein may exhibit a ratio of mean flow pore size to pore size range (“MFPS/Range” in Table 1), of at least 0.60, 0.65, 0.70, 0.75, 0.80, 0.85, 0.90 or 0.95. In further embodiments, an air-filtration web as disclosed herein may exhibit a ratio of mean flow pore size to pore size range, of less than 1.5, 1.3, 1.1, or 0.9.

It is emphasized that the arrangements disclosed herein do not merely rely on, for example, the elimination or reduction of pinholes or very large pores or providing a preponderance of very small pores. Rather, the overall character of the pore size distribution, as captured in the various parameters discussed above, seems to be important. For example, it may be that the present arrangements allow excellent fine-particle filtration to be performed but without the fibrous web being dominated by extremely small pores that would drastically increase the air resistance. In other words, it may be that the present work has provided a pore size distribution that is advantageously centered at an optimal position (e.g. in terms of the mean flow pore size), and that is also advantageously narrow and unskewed (e.g., lacking very large pores that might reduce the ability to filter fine particles, but also not being dominated by very small pores that might cause high airflow resistance). Without wishing to be restricted by theory or mechanism, the Working Examples herein demonstrate that the spunbonded webs disclosed herein are able to provide an enhanced ability to filter fine particles, without encountering excessively high pressure drop. (This advantageous ability to filter fine particles may be manifested in terms of any of several parameters that characterize various aspects of filtration performance, as will be evident from the discussions and Working Examples herein.)

While not necessarily being required in order to provide the enhanced air-filtration performance disclosed herein, various other parameters of the spunbonded web may be chosen for optimal properties. In some embodiments, properties such as loft, basis weight, and/or thickness may be chosen e.g. to impart a particular range of physical properties for a desired purpose. In some embodiments, such properties may be chosen so as to impart a desired stiffness, as may be helpful in allowing the spunbonded web to be pleated and/or to maintain a pleated configuration.

The loft of the herein-disclosed webs will be characterized herein in terms of solidity (as defined herein and as measured by procedures reported in the Test Methods of the Working Examples). By “solidity” is meant a dimensionless fraction (usually reported in percent) that represents the proportion of the total volume of a fibrous web that is occupied by the solid (e.g. polymeric fibrous) material. Further explanation, and methods for obtaining solidity, are found in the Examples section. Loft is 100% minus solidity and represents the proportion of the total volume of the web that is unoccupied by solid material. In some embodiments, a spunbonded air-filtration web as disclosed herein may exhibit a solidity of greater than 8.0%, to 18% (corresponding to a loft of from about 82% to less than 92.0%). In various embodiments, a web as disclosed herein may exhibit a solidity of greater than 8.5%, 9.0%, 11%, 13%, or 15%. In further embodiments, a web as disclosed herein may exhibit a solidity of at most 16%, 15%, 1%, 12%, or 10%.

In some embodiments, a spunbonded air-filtration web as disclosed herein may exhibit a basis weight of from 60 to 200 grams per square meter. In various embodiments, a web as disclosed herein may exhibit a basis weight of at least 70, 80, 90 or 100 grams per square meter. In further embodiments, a web as disclosed herein may exhibit a basis weight of at most 180, 160, 150, 140, 130, 120, or 110 grams per square meter. In various embodiments, a spunbonded air-filtration web as disclosed herein may exhibit a thickness of at least 0.2, 0.4, 0.6, 0.8, 1.0, 1.5, 2.0, or 3.0 mm. In further embodiments, a web as disclosed herein may exhibit a thickness of at most 5.0, 4.0, 3.5, 2.5, 1.5, 0.7, or 0.5 mm. (Thickness and basis weight will be measured according to the procedures used in the measurement of solidity.)

The fibers of a collected mass of fibers can be bonded to form a spunbonded web in any desired manner. In some embodiments the bonding may be performed so as to avoid an excessive degree of permanent compaction of the web in the bonding process, e.g. as desired in order to achieve a web with a particular loft. In some embodiments the fibers may be autogenously bonded as described herein; such a process typically results in little or no permanent compaction of the web. In some embodiments, such autogenous bonding may be supplemented e.g. by point-bonding (achieved e.g. by a calendering roll operated at a suitable temperature and pressure). In some such cases, the point-bonding may be held to the minimum that will provide the desired augmenting of the bonding, without unduly compacting a large area of the web. For example, in various embodiments point-bonding may be performed so that the point-bonds occupy less than 4.0, 3.0, 2.0, or 1.0% of the area of the web (as a ratio of the collective area of the actual point-bonds to the total area of the web). In further embodiments, point-bonding may be performed so that the point-bonds occupy at least 0.1, 0.2, 0.4 or 0.8% of the area of the web.

Spunbonded air-filtration webs as disclosed herein may exhibit any suitable stiffness, e.g. as desired in order that the web be amenable to being pleated. In various embodiments a spunbonded air-filtration web as disclosed herein may exhibit a Gurley Stiffness (measured according to the procedures outlined in the Working Examples herein) of at least 500, 600, 700, 800, 900, or 1000. In further embodiments the web may exhibit a Gurley Stiffness of less than 2000, 1500, 1200, or 1100. Those of ordinary skill will readily appreciate how parameters such as e.g. loft, basis weight, and/or thickness (as well as bonding methods and/or conditions) can be selected to influence the stiffness of the web.

### Filtration Performance

Webs as described herein can exhibit enhanced particle-filtration performance (in air filtration), e.g. in combination with low pressure drop. Filtration performance may be characterized by any of the well known parameters including e.g. Percent Penetration (and its converse, Capture Efficiency, which is 100 minus Percent Penetration), Pressure Drop, Quality Factor, and so on. Various air-filtration parameters and procedures for evaluating such and parameters are described in the Test Methods of the Working Examples. In various embodiments, a spunbonded air-filtration web as disclosed herein may comprise a Quality Factor (QF) of at least about 0.25, 0.3, 0.35, 0.40, 0.50, 0.75, 1.0, 1.25, or 1.5. In various embodiments, such a QF may be achieved when tested with NaCl at 32 liters per minute (LPM), NaCl at 85 LPM, dioctyl phthalate (DOP) at 32 LPM, or DOP at 85 LPM.

In various embodiments, a spunbonded air-filtration web as disclosed herein may exhibit an airflow resistance (i.e., Pressure Drop, measured according to the procedures outlined in the Test Methods herein) of less than 25, 20, 15, 10, 8, or 6 mm of water, at a flowrate of 85 liters per minute (face velocity of 14 cm/s).

In various embodiments, a spunbonded air-filtration web as disclosed herein may exhibit a Percent Penetration (measured with NaCl particles at 32 liters per minute, according to the procedures disclosed in the Test Methods herein) of less than 1.0, 0.6, 0.4, 0.2, 0.1, or 0.05.

In some embodiments, a spunbonded air-filtration web as disclosed herein may exhibit HEPA filtration, which is defined herein as exhibiting a particle Capture Efficiency of at least 99.97% (in other words, allowing a Percent Penetration of 0.03 or less) of particles at least down to a size of 0.3 μm. As defined herein, the exhibiting of HEPA filtration denotes specifically denotes that a Capture Efficiency of at least 99.97% is achieved when using NaCl particles generated at a mass mean diameter of approximately 0.26 μm (which corresponds to a count mean diameter of approximately 0.075 μm, according to TSI CERTITEST Automated Filter Testers Model 8130 data sheet) at 32 liters per minute according to the procedures disclosed in the Test Methods herein. In some embodiments, a spunbonded air-filtration web as disclosed herein may also achieve such performance when tested using DOP particles (at 32 liters per minute) rather than NaCl particles.

Another measure of air-filtration performance is found in the revised China National Standard for testing and rating room air purifier performance, GB/T 18801-2015, as effective Mar. 1, 2016. The Standard includes a Clean Air Delivery Rate (CADR) for particulates. CADR is a measure of the total air cleaning performance of an air-filtering device (e.g. a room air purifier), including both fan and filter performance, and it is reported in units of volume flow, for example m³/hr. The Standard also includes a new service life test for particulate-capture, called particulate CCM (cumulate clean mass). Simply put, the particulate CCM test measures the amount of particulates (derived from cigarette smoke) that the filter media of the air-filtering device is able to capture when the device performance (in CADR) has dropped to 50% of its starting value. The particulate CCM is measured in milligrams of particles (cigarette-smoke particles) captured; the performance is reported on a discrete scale with levels from P1-P4, with 4 being the highest grade.

Some embodiments disclosed herein relate to a room air purifier equipped with a filter media comprising (e.g. consisting of) a spunbonded air-filtration web as disclosed herein. In some embodiments, such a room air purifier exhibits a particulate CCM of P4 per the China National Standard. In some embodiments, the room air purifier exhibits a particulate CCM of P4 per the China National Standard, with a spunbonded air-filtration web of less than 1.5 m² in area. In some embodiments, the room air purifier exhibits a particulate CCM of P4 per the China National Standard, with a spunbonded air-filtration web of less than 1.2 m² in area.

As part of the present investigations, a test of air-filtration performance has been used that is derived from the above-described China National Test, but is arranged to characterize the performance of an air-filtration media rather than characterizing the combined effect of the filter media and the operating behavior (e.g. as affected by the fan) of a powered air-filtration device, such as a room air purifier, that the media is used in. This test is referred to as a Media CCM test, and is described in detail in U.S. Provisional Patent Application No. 62/379,772, in the resulting International (PCT) application published as WO2018/039231, and in the resulting U.S. patent application Ser. No. 16/328,401, all of which are incorporated by reference in their entirety herein.

In the Media CCM test, a sample of filter media is incrementally exposed to greater and greater amounts of a contaminant (cigarette smoke). The filtration performance of the filter media is monitored periodically as a function of this cumulative exposure to the contaminant. The filtration performance is measured in terms of the Capture Efficiency (efficiency of removal of NaCl challenge particles; in other words, 100 minus the Percent Penetration) as described in the WO'9231 publication. The test is concluded when the Capture Efficiency has dropped to half of its initial value (that is, the value before any exposure to the contaminant). The Media CCM value is thus a measure of the total amount of contaminant (reported as the number of cigarettes per square meter of filter media) to which the filter media has to be exposed to cause the filtration performance to drop by half. A higher Media CCM value indicates that a filter media is able to withstand a greater level of contaminant before its filtration performance drops significantly.

In various embodiments, a spunbonded air-filtration web as disclosed herein may exhibit a Media CCM of greater than 100, 150, 300, 300, 400, 500, 600 or 700 cigarettes per square meter when tested according to the Media CCM test.

Ordinary artisans will appreciate that the particulate CCM test of the China National Standard, and the Media CCM test, evaluate the ability of an air filter to maintain an initial filtration performance, but the reported score does not include the actual initial performance (or final performance). Thus, these tests only reveal certain aspects of filter performance. For example, an air filter might exhibit a high CCM but poor “absolute” filtration performance e.g. in terms of Percent Penetration, Capture Efficiency, and/or Quality Factor, indicating that the air filter performance is rather stable but that the absolute magnitude of the filtration performance is poor.

The discussions herein make it clear that in at least some embodiments, the herein-disclosed spunbonded air-filtration webs can exhibit excellent absolute filtration performance (evaluated in terms of e.g. Percent Penetration, Capture Efficiency, Quality Factor, and so on) and can also exhibit excellent CCM values, meaning that this excellent filtration performance is retained even after significant contamination of the filter by particulates. Notably, the CCM values achievable by the herein-disclosed spunbonded air-filtration webs are significantly higher than those exhibited by conventional spunbonded air-filtration webs, as evidenced by the Working Examples herein.

It is further noted that in at least some embodiments, the spunbonded air-filtration webs disclosed herein can achieve HEPA filtration performance. To the inventors' knowledge, such performance (e.g., HEPA performance as achieved with a layer of spunbonded fibers, in the absence of e.g. meltblown fibers and other fibers as discussed later herein) has not been demonstrated for spunbonded air-filtration webs of the art. In fact, the discussions herein make it clear that the achieving of this enhanced filtration performance by a spunbonded web is an unexpected result.

It is emphasized that the particle-filtration performance of an air filter may be characterized according to several different performance aspects, and that a filter need not necessarily exhibit superior values of every possible performance parameter, in order to be advantageous. Thus, even if a filter does not exhibit, for example, a particularly high of removal of NaCl particles as manifested in an extremely low Percent Penetration, the filter may nevertheless exhibit e.g. an advantageously high Quality Factor, an advantageously low flow resistance (Pressure Drop), and/or an advantageously high Media CCM.

The herein-disclosed spunbonded air-filtration webs can achieve excellent filtration performance without the need to include a significant number of so-called nanofibers in the web. By a nanofiber is meant a fiber whose diameter is less than 1.0 μm (as a measurement of the diameter of that individual fiber, rather than an average Actual Fiber Diameter of a fiber population as described above). While nanofibers have been used in the art to enhance the ability of a filtration web to remove fine particles, such fibers exhibit various drawbacks. For example, they may be difficult to make (e.g. requiring a specialized process such as electrospinning). Furthermore, the small size of the nanofibers may impart high airflow resistance to the web and/or render the web so weak that it is difficult to pleat and/or must be disposed on a second, supporting layer. Thus, the present disclosure uses meltspun fibers in a size range that enables the web to be readily pleatable without the need for a supporting layer; and, that are arranged so that interstitial pores are provided that achieve excellent particulate removal without the disadvantage of high airflow resistance.

Thus in some embodiments, a spunbonded air-filtration web as disclosed herein may be at least generally free of nanofibers. By generally free of nanofibers is meant that less than 1 fiber out of every 20 fibers of the web is a nanofiber. In some embodiments, the meltspun air filtration web is substantially free (less than 1 fiber out of every 50) or essentially free (less than 1 fiber out of every 100) of nanofibers. In further embodiments, the meltspun filtration web may be generally, substantially, or essentially free of fibers with a diameter of less than 0.5 μm, 1.5 μm, 2.0 μm, or 3.0 μm.

Similarly, the herein-disclosed spunbonded air-filtration web, formed from meltspun fibers, possesses advantages over meltblown webs. Meltblown webs, while having found use in e.g. HEPA filtration, are typically so weak that they must be accompanied by (e.g., laminated or otherwise bonded to) one or more supporting layers or webs so that the combined structure has adequate mechanical integrity, has sufficient stiffness in order to be pleated if desired, and so on (as discussed e.g. in the Background of U.S. Pat. No. 5,721,180).

Thus, in some embodiments a spunbonded air-filtration web as disclosed herein, can serve as a stand-alone filtration layer, e.g. in the absence of any other filtration layer such as e.g. a meltblown layer, a nanofiber layer, and so on. Furthermore, in some embodiments the herein-disclosed spunbonded air-filtration web will be at least generally, substantially, or essentially free (as defined above) of meltblown fibers, and/or multicomponent fibers, and/or crimped fibers, and/or “fiber bundles” of the general type described in U.S. Patent Publication No. 2015/0135668. That is, the inclusion of such entities is not needed to achieve the effects disclosed herein.

### Methods and Apparatus for Making

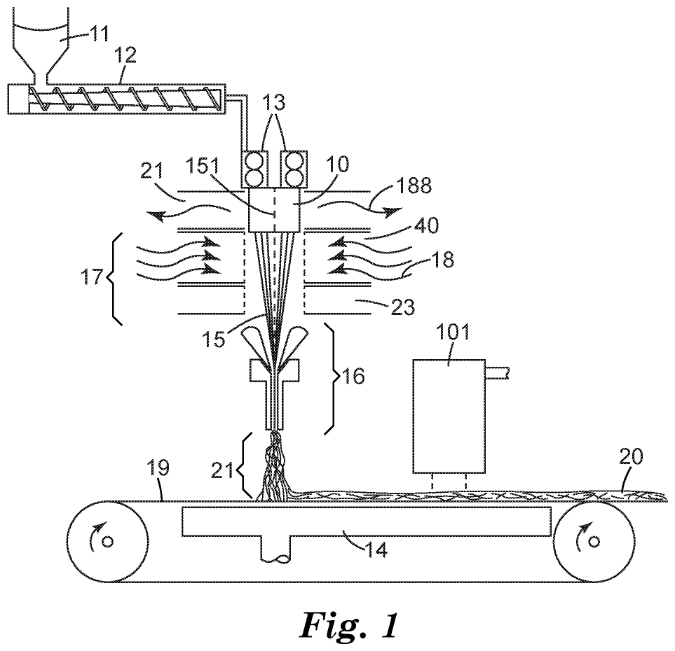

FIG. 1 shows an exemplary apparatus (viewed from the side, i.e. along the lateral direction of the apparatus) which may be used to form spunbonded air-filtration webs as disclosed herein. In an exemplary method of using such an apparatus, polymeric fiber-forming material is introduced into hopper 11, melted in an extruder 12, and pumped into extrusion head 10 via pump 13. Solid polymeric material in pellet or other particulate form is most commonly used and melted to a liquid, pumpable state.

Extrusion head (die) 10 may be a conventional spinnerette or spin pack, generally including multiple orifices arranged in a regular pattern, e.g., straightline rows, staggered rows, or the like. The orifices will be spaced along a long axis of the extrusion head, which long axis is typically aligned with a lateral axis of the meltspinning apparatus. Multiple filaments 15 of fiber-forming liquid are extruded from the orifices of the extrusion head and travel through air-filled space 17 to attenuator 16. The multiple extruded filaments 15 will be collectively referred to herein as a filament stream, which will have a lateral extent (width) that is aligned with the long axis of the extrusion head and that is largely dictated by the length of the rows of the orifices of the extrusion head. (The lateral direction of the meltspinning apparatus and the filament stream is in-out of plane in the view of FIG. 1.) The filament stream, as emitted from the extrusion head (and before it is gathered into a more tightly packed stream as it approaches the attenuator, as evident in FIG. 1) will have a fore-aft extent that extends left-right in the view of FIG. 1, and will have a fore-aft centerline 151 as shown in FIG. 1. (The fore-aft direction typically corresponds to the direction along which the fiber collector 19 (e.g. a moving belt) travels.)

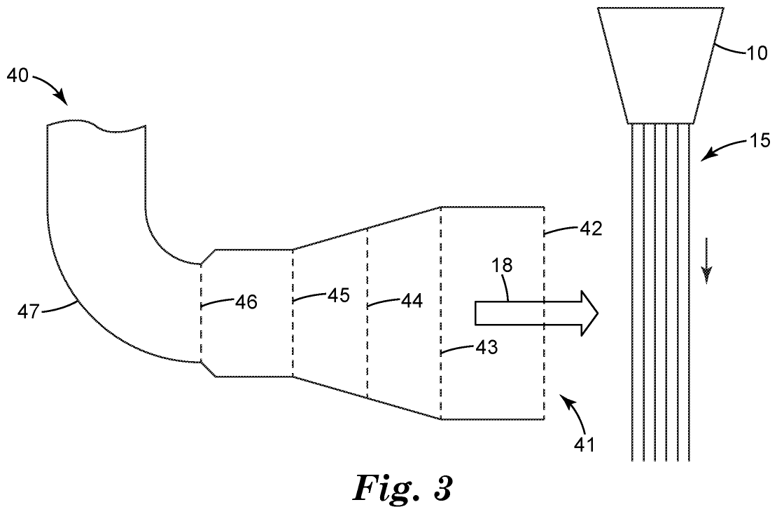

Often, such a meltspinning apparatus is configured so that the filament stream travels vertically downward, in the general manner indicated in FIG. 3. The distance the filament stream 15 travels through air space 17 before reaching the attenuator 16 can vary, as can the conditions to which the filaments are exposed. In some embodiments (e.g. as in the exemplary arrangement of FIG. 1) the melt-spinning apparatus may be an “open” system in which at least some portions of air space 17 are in fluid communication with the ambient environment. In other embodiments, the melt-spinning apparatus may be a closed system in which air space 17 is enclosed e.g. by one or more shrouds, housings, or the like such that essentially no portion of air space 17 is in fluid communication with the ambient environment.

In some embodiments, an exhaust device 21, operating in suction mode and positioned relatively close to the extrusion head, may be employed to remove an air stream 188 from the vicinity of the extrusion head. In some embodiments (depending e.g. on the specific position at which the exhaust device 21 is located) such an air stream 188 may contribute slightly to the quenching of the filaments 15. However, in many embodiments such an air stream 188 may serve primarily to remove undesired gaseous materials or fumes released during extrusion, thus air stream 188 will be referred to herein as an exhaust air stream. In various embodiments, such an exhaust device 21 may be positioned roughly even with extrusion head 10 (as depicted in generic representation in FIG. 1 herein) and/or may extend slightly below the extrusion head (e.g. as in the exemplary device that handles airstream 18a as shown in FIG. 1 of U.S. Pat. No. 7,807,591).

In air space 17, at least one quenching air-delivery device 40 may be used to direct at least one quenching stream of air 18 toward the stream of extruded filaments 15 to reduce the temperature of the extruded filaments 15 e.g. so that the filaments become at least partially solidified into fibers. (Although the term “air” is used for convenience herein, it is understood that other gases and/or gas mixtures may be used in the quenching and drawing processes disclosed herein). Such an air stream(s) 18 may often be directed toward the filament stream along a direction at least generally transverse to the filament stream (as in FIG. 1), may serve primarily to achieve temperature reduction of the fibers, and thus will be referred to as a quenching air stream to distinguish it from the above-mentioned optional exhaust air stream 188. In some embodiments a quenching air stream 18 or set of streams may be directed toward the extruded filaments from one side only (e.g. from the fore side or from the aft side). In some embodiments, two such quenching air-delivery devices 40 may be used to direct air streams toward the extruded filaments from two generally opposite (e.g. fore and aft) sides, as in the exemplary arrangement of quenching air streams 18 of FIG. 1. In some embodiments quenching air streams may be delivered through a set of air-delivery devices that are in a stacked arrangement (e.g. spaced along the path of the filament stream) and that can be operated independently. For example, in the exemplary arrangement of FIG. 1, a second set of air-delivery devices 23 is depicted, arranged below the above-described set of air delivery devices 40 (in the depicted arrangement, the second set of air-delivery devices 23 are not actively delivering air streams).

The temperature of the quenching air may be any suitable value, e.g. from about 40 F to about 80 F. In some embodiments, the quenching air may be ambient air, e.g. used at whatever temperature the ambient air exhibits in the environment in which the melt-spinning operation resides. However, in many embodiments, it may be helpful that the quenching air (as measured e.g. at an outlet of an air-delivery device that directs the quenching air onto the filament stream) exhibits a temperature of 60 F or less. In various embodiments, the quenching air may be delivered at a temperature of less than 55, 51, or 47 degrees F. In further embodiments, the quenching air may be delivered at a temperature of at least 40, 44, 48, or 52 degrees F.

The flow rate of the quenching air (in face velocity, as measured at a location proximate the outlet of the air-delivery device) may be any suitable value that allows the effects disclosed herein to be achieved. In some embodiments, the quenching air may be delivered at a face velocity of from 0.25 to 2.0 meters per second. In further embodiments, the quenching air may be delivered at a face velocity of from 0.50 to 1.0 meters per second.

The character of the quenching air stream(s), in particular the spatial and temporal uniformity of the quenching airflow, may be manipulated to advantage to produce webs with uniquely enhanced filtration properties, as discussed in detail later herein.

At least partially-solidified filaments 15 then pass through an attenuator 16 (discussed in more detail below) and can then be deposited onto a collector surface, e.g. a generally flat (by which is meant comprising a radius of curvature of greater than 15 cm) collector surface 19, to be collected as a mass 20 of meltspun fibers. In various embodiments, collector surface 19 may comprise a single, continuous collector surface such as provided by a continuous belt or a drum or roll e.g. with a radius of at least 15 cm. Collector 19 may be generally porous and gas-withdrawal (vacuum) device 14 can be positioned below the collector to assist deposition of fibers onto the collector. The distance 121 between the attenuator exit and the collector may be varied to obtain different effects. In some embodiments a meltspinning apparatus may comprise two (or more) extrusion/quenching/attenuating apparatus, e.g. in an in-line arrangement. Such an arrangement may sequentially deposit fibers so as to build of mass of fibers of a desired total thickness (as opposed to building this thickness with fibers from a single extrusion/quenching/attenuating apparatus). The mass of fibers can then be bonded e.g. as described below; the resulting article will be considered to be a single layer meltspun/spunbonded web. After collection, the collected mass 20 (web) of meltspun fibers may be subjected to one or more bonding operations, e.g. to enhance the integrity and/or handleability of the web. In some embodiments, such bonding may comprise autogenous bonding, defined herein as bonding performed at an elevated temperature (e.g., as achieved by use of an oven and/or a stream of controlled-temperature air) without the application of solid contact pressure onto the web. Such bonding may be performed by the directing of heated air onto the web, e.g. by the use of controlled-heating device 101 of FIG. 1. Such devices (sometimes referred to as through-air bonders) and methods of using such devices are discussed in further detail in U.S. Patent Application 2008/0038976 to Berrigan et al., which is incorporated by reference herein in its entirety.

In some embodiments (for example if it is desired to enhance the bonding beyond that provided by autogenous bonding), it may be useful to perform a secondary or supplemental bonding step, for example, point-bonding or calendering. As noted earlier herein, in some embodiments any such bonding method may (e.g. by using a calendering roll suitably equipped with number of small protrusions) provide point-bonds that collectively occupy a small portion (e.g. less than e.g. 4.0, 3.0, 2.0, or 1.0 percent) of the total area of the web.

A thus-produced spunbonded web 20 may be conveyed to other apparatus such as embossing stations, laminators, cutters and the like, wound into a storage roll, etc.

Various aspects of melt-spinning processes, attenuation methods and apparatus, and bonding methods and apparatus (including autogenous bonding methods) are described in further detail e.g. in U.S. Pat. Nos. 6,607,624 and 7,807,591, the entire disclosures of which are incorporated herein by reference in their entireties.

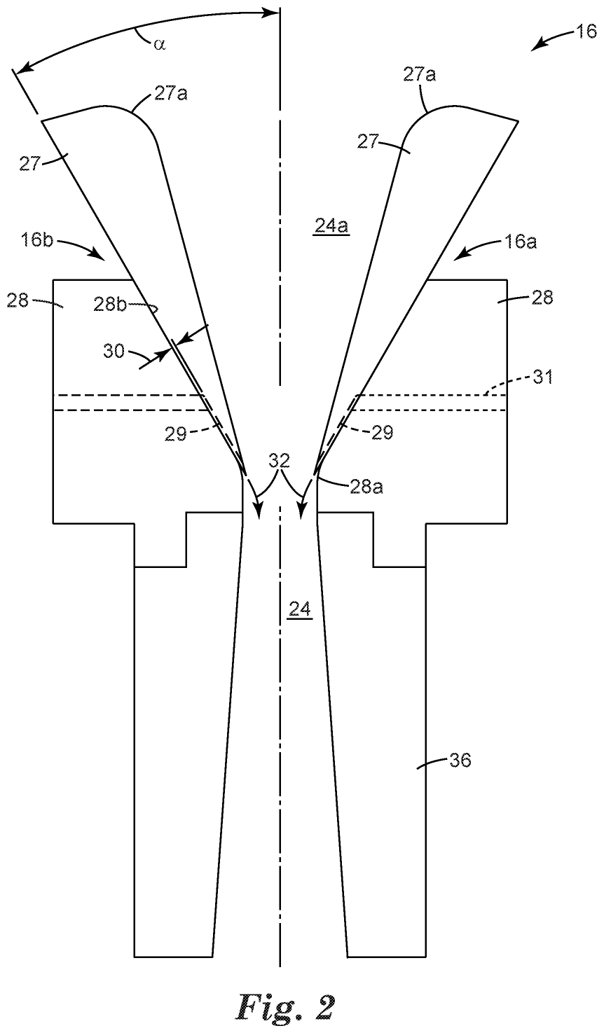

FIG. 2 is an enlarged side view of an exemplary attenuator 16 through which filaments 15 may pass. Attenuator 16 serves to at least partially draw filaments 15 and may serve to cool and/or quench filaments 15 additionally (beyond any cooling and/or quenching of filaments 15 which may have already occurred in passing through the distance between extrusion head 10 and attenuator 16). Such at least partial drawing may serve to achieve at least partial orientation of at least a portion of each filament, with commensurate improvement in strength of the solidified fibers produced therefrom (thus further distinguishing such fibers from, for example, melt-blown fibers that are not drawn in this manner).

Exemplary attenuator 16 in some cases may comprise two halves or sides 16a and 16b separated so as to define between them an attenuation chamber 24, as in the design of FIG. 2. Although existing as two halves or sides (in this particular instance), attenuator 16 functions as one unitary device and will be first discussed in its combined form. Exemplary attenuator 16 includes slanted entry walls 27, which define an entrance space or throat 24a of the attenuation chamber 24. The entry walls 27 preferably are curved at the entry edge or surface 27a to smooth the entry of air streams carrying the extruded filaments 15. The walls 27 are attached to a main body portion 28, and may be provided with a recessed area 29 to establish an air gap 30 between the body portion 28 and wall 27. Air may be introduced into the gaps 30 through conduits 31. The attenuator body 28 may be curved at 28a to smooth the passage of air from the air knife 32 into chamber 24. The angle (α) of the surface 28b of the attenuator body can be selected to determine the desired angle at which the air knife impacts a stream of filaments passing through the attenuator.

Attenuation chamber 24 may have a uniform gap width; or, as illustrated in FIG. 2, the gap width may vary along the length of the attenuator chamber. The walls defining at least a portion of the longitudinal length of the attenuation chamber 24 may take the form of plates 36 that are separate from, and attached to, the main body portion 28.

In some embodiments, certain portions of attenuator 16 (e.g., sides 16a and 16b) may be able to move toward one another and/or away from one another, e.g. in response to a perturbation of the system. Such ability may be advantageous in some circumstances.

Further details of attenuator 16 and possible variations thereof are found in U.S. Patent Application 2008/0038976 to Berrigan et al. and in U.S. Pat. Nos. 6,607,624 and 6,916,752, all of which are incorporated herein by reference for this purpose.

### Quenching

In the present investigation, it has been discovered that in deviating from conventional operation of meltspinning processes, unique and advantageous webs can be produced. The inventors have found that this can be enabled by carefully controlling the character of the quenching air used in a quenching operation as described above. Specifically, it has been found that delivering quenching airflow to the filament stream in a condition in which the airflow is extremely temporally and spatially uniform is a significant factor. That is, minimization (to a much greater degree than heretofore known to be used in quenching of meltspun filaments) of the presence, size, and/or duration of any airflow fluctuations (including but not limited to e.g. eddies, vortices, flutter, and so on) has been found to result in significant enhancements in the characteristics of the thus-produced meltspun fibers.

In aid of this, significant enhancements to the airflow uniformity have been achieved by positioning one or more airflow-smoothing entities in the quenching airflow path. In particular, it has been found that positioning one or more such airflow-smoothing entities at or near the outlet of the air-delivery device that is used to deliver the quenching air to the filament stream, e.g. relatively close to the filament stream, can be helpful. (The entity is positioned so that all of the airflow must pass through the entity; in other words, no portion of the airflow can bypass around a perimeter edge of the airflow-smoothing entity.) In at least some instances, the airflow uniformity may be further enhanced by using multiple airflow-smoothing entities spaced in series along at least a portion of the path of the quenching airflow. Such arrangements may be particularly helpful e.g. in instances in which the air-delivery device undergoes one or more changes in cross-sectional area, e.g. expansions, and/or changes in direction, along the airflow path.

An airflow-smoothing entity can be any item (e.g. a sheet material) that comprises suitable passages (e.g. through-openings) that permit an appropriate flowrate of gaseous fluid therethrough. Such a sheet material may be chosen from e.g. mesh screens (whether of a regular pattern such as a woven screen, or of an irregular pattern such as an expanded metal or sintered metal mesh). Such a sheet material may also be chosen from perforated sheeting, e.g. microperforated metal sheeting with a suitable chosen hole size and hole pattern. In general, any material that possesses the requisite combination of appropriate flow resistance and adequate mechanical integrity may be used. The through-openings of the material need not be e.g. well-defined orifices of the type found in a perforated sheet. Rather, the material may comprise tortuous paths that, in overall combination, provide the desired flow resistance. In many embodiments such an airflow-smoothing entity may be positioned at least generally transverse to the quenching airflow, e.g. so that the airflow impinges on the airflow-smoothing entity at an angle that close to normal incidence.

From the above discussions it will be appreciated that it may also be helpful to minimize the number of bends, elbows, size transitions, and the like, in any air-delivery device (e.g. ducting) that is used to deliver the quenching air stream to the filament stream. Similarly, minimizing the number of items such as bolts, screws, nuts, flanges, and so on, that protrude into the interior of the ducting in a way that might disrupt the airflow, may be helpful. Minimizing the abruptness of any size transitions in the air-delivery ducting may likewise be helpful. Also, it has been found helpful to include an airflow-smoothing entity or entities at or near transitions in the size of the ducting, as discussed below.

The spatial uniformity of the quenching airflow may be characterized by measurements of the airflow at different locations over the area of the outlet of the air-delivery device, and reporting the results in terms of the coefficient of variation that is achieved. In various embodiments, the coefficient of (spatial) variation of the airflow face velocity may be less than 8, 6, 4, 3 or 2%. Similar results may be achieved for the time-variation of the airflow velocity at any particular location of the outlet.

It can also be helpful to size such a quenching air stream (e.g. as dictated by an outlet of an air-delivery device) so that it is wide in relation to the total lateral extent (width) of the filament stream. In other words, not only should the quenching airflow be as uniform as possible, this uniform airflow should occur over a lateral width that is large enough that all of the filaments experience similar airflow (rather than, for example, some filaments experiencing a different airflow field due to being positioned at the very edge of the quench air stream). Thus, in many embodiments the outlet of an air-delivery device may extend at least somewhat beyond the lateral boundaries of the set of orifices through which the filaments are extruded. In various embodiments the outlet of the air-delivery device may be longer than the length of the set of orifices, by at least 10, 20, 40, or 80%.

It has also been found that it can be helpful to impinge quenching airflow onto the filament stream from both sides (as for airstreams 18 of FIG. 1) rather than only from a single side. This is actually somewhat counterintuitive since it might seem that two opposing air streams meeting and e.g. colliding head-on in the midst of the filament stream might generate non-uniformities. Nevertheless, double-sided quenching has so far been found to be superior to single-sided quenching in at least some aspects. It may also be helpful to configure the meltspinning extrusion head (die) so that the orifices through which the filaments are emitted are spaced appropriately to facilitate a uniform flow of quenching air through the filament stream.

It will thus be appreciated that the arrangements disclosed herein can provide that the local airflow rate (e.g. as characterized by the face velocity) of the quench air as it emerges from the outlet of the quenching air-delivery device will be extremely uniform, over the length and breadth of the outlet, and over time. It is noted that the desirability of quenching airflow that is extremely temporally and spatially uniform in comparison to quenching airflow as conventionally used in meltspinning processes of the art, does not mean that the quenching airflow is, or needs to be, in laminar flow.

An illustrative example of an air-delivery device 40 that has proven useful in delivering a uniform stream of quench air to a filament stream for the purposes disclosed herein is depicted in FIG. 3. Air-delivery device 40 (which is viewed in FIG. 3 along the lateral axis of the meltspinning apparatus; that is, along the same direction as the view of FIG. 1) can deliver an airstream 18 in the general manner illustrated in FIG. 1. Quench air 18 is delivered through an outlet 41 of device 40, e.g. in a direction substantially normal to the filament stream 15. Although not shown in FIG. 3, in many embodiments, a similar (e.g., mirror-image) device 40 may be provided on the opposite side of the filament stream so that the two devices bracket the filament stream in the fore-aft direction to deliver opposed air streams 18 (that is, to perform double-sided quenching) in the general manner shown in FIG. 1.

In some embodiments, an outlet 41 of an air-delivery device 40 may be positioned relatively close to filament stream 15. In various embodiments, outlet 41 may be positioned (at the point of closest approach to the filament stream) no more than 25, 20, 18, 15, or 13 cm from the fore-after centerline 151 of filament stream 15. In further embodiments, outlet 41 may be positioned at least 7, 10 or 13 cm from centerline 151.

Air-delivery device 40 may comprise at least one airflow-smoothing entity 42; in various embodiments, such an entity may be located within 25, 20, 15, 10, 5, or 2 cm from outlet 41. In some embodiments, such an entity 42 may be positioned within 1.0 cm of (e.g., essentially flush with) outlet 41, as in the exemplary design of FIG. 3. In many embodiments, such an entity 42 may take the form of a sheet-like material of the general type mentioned above, e.g. a mesh screen or the like. Typically, such an entity will be positioned (oriented) so that a major plane of the entity is at least generally, substantially, or essentially normal to the air stream that flows through the entity (as in FIG. 3). Similarly, such an entity 42 may often be positioned so that the quenching air stream emerging from the entity is impinged onto the filament stream 15 along a direction that is at least generally, substantially or essentially normal to the filament stream.

Any such airflow-smoothing entity 42 may comprise any suitable combination of % open area and opening size. In various embodiments, an airflow-smoothing entity 42 may comprise a % open area of at least 20, 25, 30, or 35. In further embodiments, an airflow-smoothing entity 42 may comprise a % open area of at most 70, 60, 50, or 40. In various embodiments, an airflow-smoothing entity may comprise an average opening size of at least 1, 2, 3, 4, or 5 thousandths of an inch (all such sizes are diameters, or equivalent diameters in the case of non-circular openings, e.g. as defined by wires of a mesh screen). In further embodiments, an airflow-smoothing entity may comprise an average opening size of at most 200, 150, 100, 50, 20, 10, 5.5, 4.5, 3.5, 2.5, or 2.0 thousandths of an inch. In particular embodiments, an airflow-smoothing entity may comprise a % open area of from 30 to 40, and an average opening size of from 2.0 to 4.0 thousandths of an inch. In particular embodiments, an airflow-smoothing entity may take the form of a mesh screen, e.g. a 400 mesh, 325 mesh, 270 mesh, 200 mesh, or 160 mesh screen.

In some embodiments, an air-delivery device 40 may comprise an airflow-smoothing entity 42 that is a primary airflow-smoothing entity (meaning located closest to the filament stream), along with one or more secondary airflow-smoothing entities that are located upstream (along the air-delivery pathway) from the primary entity. In particular, if the air-delivery device comprises a relatively small-diameter (or equivalent diameter) source duct 47 and expands to a larger final dimension at outlet 41 (as in the exemplary design of FIG. 3), one or more screens may be provided, e.g. at or near positions at which the air-delivery device is expanding. One such arrangement is shown in exemplary embodiment in FIG. 3, in which secondary entities (screens) 43, 44, 45, and 46 are provided, for a total of five airflow-smoothing entities. In some embodiments, the airflow-resistivity of the airflow-smoothing entities may increase along the downstream direction of the airflow path, e.g. with the primary airflow-smoothing entity being the most flow-resistive (e.g. taking the form of a tighter mesh or screen) than the upstream airflow-smoothing entities. While not visible in FIG. 3, in some embodiments an air-delivery device may expand in a lateral direction (e.g. to a total width that is wider than the filament stream as noted above) in addition to expanding along the direction of motion of filament stream 15 (e.g. in a vertical direction) as shown in FIG. 3, along the downstream direction of the airflow.

Further details of exemplary air-delivery devices 40, including types of airflow-smoothing screens, spacings and so on, are found in the Working Examples herein.

Although not shown in FIG. 3, in some embodiments multiple quench-air delivery devices 40 may be provided in a stacked arrangement, e.g. spaced along the direction of motion of filament stream 15 (e.g. with a lower air-delivery device corresponding to secondary air-delivery device 23 of FIG. 1). The portion of air space 17 over which quenching occurs thus may be divided into multiple zones in which the quench air is controlled independently. In such zones, the airflow characteristics, the airflow rate, and/or the temperature of the quench air, may be independently controlled as desired. As noted in the Working Examples, in some instances a secondary air-delivery device 23, even if present, may not need to be actively operated to deliver quenching air. That is, in some instances sufficient quenching may be achieved by a “primary” air-delivery device. In other instances, depending e.g. on the number and flowrate of the filaments 15, it may be helpful to actively operate a secondary air-delivery device. In some circumstances, even if a secondary air-delivery device does not appear to be performing a significant amount of additional quenching, the active use of such a device may aid in steering the filament stream into the attenuator.

An exhaust device for removing an exhaust air stream in proximity to the extrusion head (as discussed earlier), is not depicted in FIG. 3. Any such item would typically be positioned upward of quench-air outlet 41, e.g. roughly even with extrusion head 10 (e.g. as for exhaust device 21 as shown in FIG. 1) and/or between extrusion head 10 and outlet 41. In some embodiments, provisions may be made to actively exhaust quench air from the vicinity of the filament stream after the quench air has been delivered to the filament stream. However, in some embodiments there may be no need to provide a dedicated quench-air-removal system for such purposes. (Ordinary artisans will appreciated that in many instances the above-described attenuator 16 may serve to remove much of the quench air.)

Based on the disclosures herein, it will be straightforward for those of ordinary skill in the art of meltspinning to arrive at a suitable arrangement of quenching conditions for any particular meltspinning operation.

The inventors have found that arrangements as described above can allow solidified meltspun filaments to be collected in an arrangement that allows enhanced air-filtration to be achieved. It may reasonably be asked, and has been the subject of much consideration by the inventors, how the conditions upstream, in the quenching section of a melt-spinning operation, can affect the way in which the fibers are arranged when collected downstream, after a subsequent (attenuation) drawing operation. What has become clear in the present investigations is that any such impact of the upstream quenching conditions on the geometric and structural characteristics of the resulting webs is subtle. In examining webs by visual microscopy and electron microscopy (both in surface (plan) view and with microtomed cross-sectional views) and by X-ray microtomography it has not yet been possible to observe any readily apparent differences in the way the fibers are arranged, between meltspun webs made according to the methods disclosed herein, and meltspun webs made conventionally. However, the use of the arrangements disclosed herein has consistently been found to result in pore-size characteristics (in particular the ratio of Mean Flow Pore Size to Pore Size Range as discussed below) that differ from that of conventionally-made meltspun webs. And, meltspun/spunbonded webs with such properties have been consistently found to exhibit enhanced air-filtration performance, as evidenced in the Working Examples herein. These consistent differences in pore-size characteristics and commensurate differences in air-filtration performance indicate that in the present work, something is clearly different in how the fibers are arranged to provide interstitial pores.

It will thus be appreciated that (irrespective of the following discussions regarding specific web features or fiber arrangements that may underlie the observed behavior) the pore size characterizations as disclosed herein, in particular the use of the ratio of Mean Flow Pore Size to the Pore Size Range, can serve as a figure of merit that is predictive of the presence or absence of enhanced air-filtration performance. That is, it seems clear that particular configurations of the tortuosity of the interstitial pores of the fibrous web are consistently manifested in particular values of this ratio; and, these values of the ratio are consistently correlated with enhanced air-filtration performance.

Without wishing to be limited by any postulated theory or mechanism, it is possible that the quenching conditions disclosed herein act to reduce the number of local “defects” in the web. In this context a “defect” is any entity that can result in a local variation in the tortuousness of a path through the interstitial pores of the fibrous web. Such a defect could conceivably take the form of e.g. twinned fibers (the term “twinned” denotes sections of two (or more) fibers that contacted each other while still soft and end up bonded to each other). It is possible that the presence of twinned fibers or other such entities, even at a low level not heretofore considered to be deleterious, may cause fibers to land on the collection belt in an arrangement that provides a locally less-tortuous path through the interstitial pores of the web. While such occurrences are not been known to have been thought of as a problem in the past e.g. unless occurring to the extent to cause pinholes or other readily recognizable issues, a further reduction in the presence of such phenomena (e.g. below levels that were heretofore considered acceptable, and even if the reduction is not easily quantifiable e.g. by any known method of optical or SEM inspection) may allow enhanced filtration performance. Such achievements may be particularly useful for filtration of fine particles, e.g. for achieving HEPA filtration.

It is emphasized that the above hypothesis has not been proven and some other phenomenon (or combination of phenomena) may play a role. Any such phenomena may involve entities that have not historically been considered to be “defects”. For example, it could be that in the absence of high uniformity of quench airflow as used herein, different segments or local areas of different filaments may be subjected to different cooling conditions such that, after solidification, the segments differ in stiffness (e.g. due to differences in crystallization and/or orientation) or in some related property. While such subtle differences might not normally be considered to be “defects”, such entities (e.g. fiber segments that differ in stiffness) might nevertheless have the above-postulated effect of causing the fibers to be collected in an arrangement that causes local variations in tortuosity. Thus, operating according to the herein-disclosed arrangements may, for example, reduce or eliminate areas of decreased local tortuosity with beneficial results in filtration performance.

The above discussions clearly involve some conjecture as to the specific mechanism involved. This fact notwithstanding, and while again not wishing to be limited by possible theory or mechanism, the inventors can attest that the source of a long-standing problem with meltspun air-filtration webs (i.e., the inability to achieve enhanced air filtration such as e.g. HEPA filtration, absent special measures such as e.g. the inclusion of nanofibers) has been identified as resulting from a failure to appreciate the advantages of extremely precise control over the temporal and spatial uniformity of the quenching airflow. For example, many patents that describe conventional melt-spinning merely report the temperature of the quench air and the bulk (overall) flowrate of the quenching air, if they mention quenching conditions at all. Simply put, until now it was not appreciated that the customary ways of providing quenching airflow could be modified to achieve the beneficial enhancements in filtration performance that are now revealed.

Examples of meltspinning operations with which the inventors are familiar, and which the inventors can attest did not take the special measures disclosed herein, include the meltspinning operations described e.g. in U.S. Pat. Nos. 6,607,624, 6,916,752, 7,807,591, 7,947,142, 8,372,175, and 9,139,940, and PCT International Patent Publication WO 2018/039231. This being the case, it cannot be concluded that the spunbonded webs described in those documents, and spunbonded webs made by similarly-described meltspinning operations, would inherently exhibit the pore size characteristics, or the filtration performance, of the webs disclosed herein.

Furthermore, the inventors affirm that the discovery that this lack of quench-air-flow uniformity is the source of a problem is unexpected. In fact, the inability of meltspun-spunbonded webs to perform e.g. HEPA filtration has historically been considered to be an inherent limitation, rather than stemming from some solvable problem with the melt-spinning arrangements. That is, spunbonded air-filtration webs in the art have not typically been thought of as being “defective”; rather, it was simply thought that such webs were not capable of, for example, achieving HEPA filtration performance. The inventors thus affirm that the discovery that meltspun/spunbonded webs can achieve enhanced air filtration as evidenced by the Working Examples herein, is unexpected.

In various embodiments, any convenient thermoplastic fiber-forming polymeric material may be used to form webs as disclosed herein. Such materials might include e.g. polyolefins (e.g., polypropylene, polyethylene, etc.), poly(ethylene terephthalate), nylon, poly(lactic acid), and copolymers and/or blends of any of these. In some embodiments, polypropylene may be particular advantageous, as noted elsewhere herein.

In some embodiments, a spunbonded air-filtration web as disclosed herein may include at least some so-called multicomponent fibers, e.g. bicomponent fibers. Such fibers may comprise e.g. a sheath-core configuration, a side-by-side configuration, a so-called islands-in-the-sea configuration; or in general, any desired multicomponent configuration.

However, although in some embodiments multicomponent fibers may be optionally present, the spunbonded webs as disclosed herein do not need to contain multicomponent fibers in order to achieve the enhanced air-filtration properties (or in order to achieve the ability to be pleated) disclosed herein. Thus, in various embodiments, less than one of every 10, 20, or 50 fibers of the spunbonded air-filtration web is a multicomponent fiber. In specific embodiments, the spunbonded air-filtration web will be a monocomponent web, which is defined herein as meaning that the web is essentially free of multicomponent fibers (i.e. with multicomponent fibers, if present at all, being present at less than one fiber per 100 fibers of the web). The term monocomponent applies to the polymeric substituent(s) of the fibers, and does not preclude the presence of additives (e.g. charging additives as discussed elsewhere herein), processing aids, and so on. While in some convenient embodiments a monocomponent fiber may be a homopolymer (e.g. polypropylene), this is not strictly necessary. Rather, the term monocomponent, in requiring a uniform polymeric composition across the cross-section of the fibers and down the length of the fibers, merely excludes bicomponent (multicomponent) fibers of the general type described above. The term monocomponent thus allows e.g. copolymers and miscible blends in addition to homopolymers, as will be readily understood by ordinary artisans.

If the fibers are monocomponent fibers, it may be advantageous to take particular care in performing autogenous bonding of the fibers. In particular, careful temperature monitoring and/or control may enhance the uniformity of the bonding. Thus, in some embodiments, apparatus and methods of the general type described in U.S. Pat. No. 9,976,771 may be used to impinge heated air in order to perform autogenous bonding.

In minimizing the amount of multicomponent fibers present, webs as disclosed herein may be advantageous in at least certain embodiments. For example, webs as disclosed herein may be comprised of monocomponent fibers that are comprised substantially of polypropylene, which may be very amenable to being charged (e.g., if desired for filtration applications). Multicomponent fibers which comprise an appreciable amount of e.g. polyethylene may not be as able to be charged due to the lesser ability of polyethylene to accept and retain an electrical charge.

In at least some embodiments, the herein-disclosed webs will comprise meltspun fibers that are at least generally continuous fibers, meaning fibers of relatively long (e.g., greater than 15 cm), indefinite length. Such generally continuous fibers may be contrasted with e.g. staple fibers which are often relatively short (e.g., 5 cm or less) and/or chopped to a definite length. Those of skill in the art will also appreciate that meltspun fibers will be distinguishable from e.g. meltblown fibers, e.g. by way of their greater length and/or evidence (e.g. orientation) of greater drawing having been performed on the meltspun fibers, in comparison to typical meltblown fibers. In general, ordinary artisans will appreciate that the individual fibers and/or the arrangement of fibers in a spunbonded web will distinguish the spunbonded web from other types of webs (e.g. from meltblown webs, carded webs, airlaid webs, wetlaid webs, and so on). It is also noted that by definition, meltspun fibers as disclosed herein (and as characterized by their individual fiber diameter and/or by the Actual Fiber Diameter of a population of such fibers) are not derived from splitting, fibrillating, or otherwise separating larger diameter fibers as originally made, into multiple smaller fibers.

In some embodiments, various additives may be added to the meltspun fibers and/or to the spunbonded webs (as noted above, such additives may be present in monocomponent fibers). In some embodiments, fluorinated additives or treatments may be present, e.g. if desired in order to enhance the oil resistance of the web. In other embodiments, no fluorinated additive or treatment will be present. In some embodiments, the meltspun fibers will be essentially free of (i.e., will include less than 0.1% by weight of) natural and/or synthetic hydrocarbon tackifier resins, including, but not limited to, natural rosins and rosin esters, C₅ piperylene derivatives, C₉ resin oil derivatives, and like materials.

In at least some embodiments a spunbonded web as disclosed herein may be charged as is well known in the art, for example by hydrocharging, corona charging, and so on. The resulting web will thus include so-called electret fibers, i.e. fibers that exhibit an at least quasi-stable electric charge. In some embodiments the fibers may include charging additives (e.g. added as melt additives in the melt-spinning process) to enhance the ability of the fibers to accept, and retain, a charge. Any suitable charging additive may be used; various charging additives that might be suitable are described e.g. in U.S. Patent Application Publication No. 2019/0003112.

One example of a hydrocharging process includes impinging jets of water or a stream of water droplets onto the spunbonded web at a pressure and for a period sufficient to impart a filtration enhancing electret charge to the web, and then drying the web. The pressure necessary to optimize the filtration enhancing electret charge imparted to the fibers may vary depending on the type of sprayer used, the type of polymer from which the fibers is formed, the type and concentration of charging additive (if present) in the fibers, and the thickness and density of the web. The jets of water or stream of water droplets can be provided by any suitable spray device. One example of a potentially useful spray device is an apparatus used for hydraulically entangling fibers of nonwoven webs. Representative patents describing hydro-charging include U.S. Pat. Nos. 5,496,507; 5,908,598; 6,375,886; 6,406,657; 6,454,986 and 6,743,464. Representative patents describing corona charging processes include U.S. Pat. Nos. 30,782, 31,285, 32,171, 4,375,718, 5,401,446, 4,588,537, and 4,592,815.

In some embodiments, one or more additional layers, for example supporting layers, pre-filter layers, and the like, may be present along with the herein-disclosed spunbonded air-filtration web. For example, in some embodiments a layer that is configured to remove gases or vapors (e.g. a layer comprising one or more sorbents such as activated carbon) may be present along with the herein-described particulate air-filtration web. In some embodiments a layer may be present that further enhances the filtration of particles. In some embodiments any such layer may be merely juxtaposed near or against the air-filtration web, e.g. without being attached to it. In other embodiments, any such layer may be combined (e.g., by lamination) with the air-filtration web to form a multilayer (laminate) filtration article.

However, an advantage of the herein-disclosed air-filtration web is that if desired, in some embodiments the web can be used as a single (standalone) layer; i.e., without any other filtration layers (e.g., layers that perform particle filtration) being present. This achieves significant advantages over arrangements in the art in which multiple air-filtration layers are needed, acting in combination, in order to achieve e.g. HEPA filtration.

In some embodiments, webs as disclosed herein may be pleated to form a pleated filter for use in air filtration. In some embodiments a pleated filter as described herein may be self-supporting, meaning that (e.g. when the filter is provided in a commonly-found nominal size of 20 inches by 20 inches (51 cm×51 cm) the pleated filter does not collapse or bow excessively when subjected to the air pressure typically encountered (e.g., 0.4 inches (1.0 cm) of water) in forced air ventilation systems. In some embodiments spunbonded air-filtration web comprising meltspun autogenously bonded electret fibers as disclosed herein may be a single (standalone) layer, e.g. with a Gurley stiffness of at least 600, 800 or 1000 mg, such that the web is readily pleatable and is self-supporting once pleated. Thus in some embodiments an air filter, e.g. a pleated air filter, may be made in which the only air-filtration web (or the only web of any kind) in the filter is the herein-disclosed web.

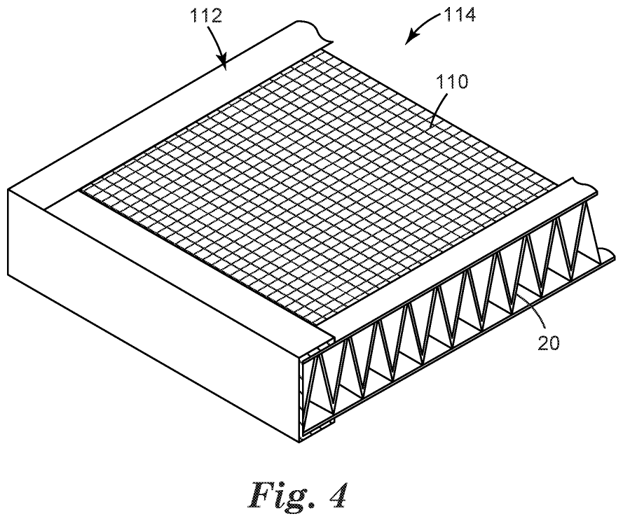

Pleated filters as described herein may comprise one or more scrims and/or a perimeter frame to enhance the stability of the pleated filter. FIG. 4 shows an exemplary pleated filter 114 with filter media comprising (e.g. consisting of) spunbonded web 20 as described herein; the pleated filter further comprises a perimeter frame 112 and a scrim 110. Although shown in FIG. 4 as a planar construction in discontinuous contact with one face of the filter media, in some embodiments scrim 110 may be pleated along with the filter media (e.g., so as to be in substantially continuous contact with the filter media). Scrim 110 may be comprised of nonwoven material, wire, fiberglass, and so on. However, in some embodiments no such scrim may be present. In some embodiments, a pleated spunbonded air-filtration web as disclosed herein, may bear a plurality of bridging filaments bonded to peaks of the pleats, on at least one major face (e.g. the upstream face and/or the downstream face) of the pleated web. Methods of providing such bridging filaments and ways that they can be arranged, are disclosed e.g. in U.S. Provisional Patent Application No. 62/346,179 and in the resulting PCT (International) Patent Application published under number WO 2017/213926, both of which are incorporated by reference herein in their entirety. In some embodiments a pleated spunbonded air-filtration web as disclosed herein, may bear a plurality of continuous adhesive strands e.g. of the general type described in U.S. Pat. No. 7,896,940. Such strands (sometimes referred to as glue beads or drizzle glue) may be substantially nonlinear, e.g. they may follow the peaks and valleys of the pleated structure.

The herein-disclosed spunbonded air-filtration webs may find use in any environment or circumstance in which it is desired to remove at least some particles, e.g. fine particles, from a moving airstream. In some embodiments, such a filter may be used in a heating-ventilation-air conditioning (HVAC) system, e.g. a residential HVAC system. In some embodiments, such a filter may be used in a room air purifier (RAP). In particular embodiments, such a filter may be used to achieve HEPA filtration, e.g. for clean room environments or the like.

### Exemplary Embodiments and Combinations

A first embodiment is a spunbonded air-filtration web comprising meltspun autogenously bonded electret fibers with an Actual Fiber Diameter of from 3.0 microns to 15 microns, wherein the web exhibits a ratio of mean flow pore size to pore size range of from 0.55 to 2.5.

Embodiment 2 is the air-filtration web of the first embodiment wherein the web exhibits a solidity of from greater than 8.0% to 18.0%, a basis weight of from 60 to 200 grams per square meter, and a Gurley stiffness of at least 500.

Embodiment 3 is the air-filtration web of any of embodiments 1-2 wherein the meltspun autogenously bonded electret fibers are monocomponent fibers.

Embodiment 4 is the air-filtration web of any of embodiments 1-3 the web comprises meltspun autogenously bonded electret fibers with an Actual Fiber Diameter of from greater than 8.0 microns, to 12.0 microns.

Embodiment 5 is the air-filtration web of any of embodiments 1-4 wherein the web is at least substantially free of nanofibers.

Embodiment 6 is the air-filtration web of any of embodiments 1-5 wherein the web exhibits a ratio of mean flow pore size to pore size range of from 0.60 to 1.0.

Embodiment 7 is the air-filtration web of any of embodiments 1-6 wherein the web exhibits a mean flow pore size of from 8 to 30 microns. Embodiment 8 is the air-filtration web of any of embodiments 1-6 wherein the web exhibits a mean flow pore size of from greater than 19 microns, to 30 microns.

Embodiment 9 is the air-filtration web of any of embodiments 1-8 wherein the web exhibits a Pore Size Range of from 10 microns to 35 microns.

Embodiment 10 is the air-filtration web of any of embodiments 1-8 wherein the web exhibits a Pore Size Range of from greater than 20 microns, to 35 microns.

Embodiment 11 is the air-filtration web of any of embodiments 1-10 wherein the web exhibits a solidity of from 9.0% to 16%.

Embodiment 12 is the air-filtration web of any of embodiments 1-11 wherein the web exhibits a basis weight of from 80 to 140 grams per square meter.

Embodiment 13 is the air-filtration web of any of embodiments 1-12 wherein the web exhibits a Gurley stiffness of at least 800.

Embodiment 14 is the air-filtration web of any of embodiments 1-13 wherein the web exhibits a pressure drop of less than 10 mm H₂O when tested at 85 liters per minute (LPM).

Embodiment 15 is the air-filtration web of any of embodiments 1-14 wherein the web exhibits a Quality Factor of at least about 1.50 l/mm H₂O, when tested with NaCl at 32 liters per minute (LPM) and/or when tested with DOP at 32 liters per minute (LPM).

Embodiment 16 is the air-filtration web of any of embodiments 1-14 wherein the web exhibits a Quality Factor of at least about 2.0 l/mm H₂O when tested with NaCl at 32 liters per minute (LPM) and/or when tested with DOP at 32 liters per minute (LPM).

Embodiment 17 is the air-filtration web of any of embodiments 1-16 wherein the web exhibits a Capture Efficiency of at least 99 percent when tested with NaCl at 32 liters per minute (LPM) and/or when tested with DOP at 32 liters per minute (LPM).

Embodiment 18 is the air-filtration web of any of embodiments 1-17 wherein the web exhibits a Media CCM of greater than 150 Reference Cigarettes per square meter of web area.

Embodiment 19 is the air-filtration web of any of embodiments 1-18 wherein the web is at least substantially free of meltblown fibers.

Embodiment 20 is an air-filtration article comprising the spunbonded air-filtration web of any of embodiments 1-19.

Embodiment 21 is the air-filtration article of embodiment 20, wherein the spunbonded air-filtration web is the only air-filtration layer of the air-filtration article.

Embodiment 22 is the air-filtration web of any of embodiments 1-19 or the air-filtration article of any of embodiments 20-21, wherein the air-filtration web is pleated to comprise rows of oppositely-facing pleats.

Embodiment 23 is a method of filtering at least particles from a moving airstream, the method comprising passing the moving airstream through the air-filtration web of any of embodiments 1-19 or through the air-filtration article of any of embodiments 20-21.

Embodiment 24 is the method of embodiment 23 wherein the air-filtration web or the air-filtration article is installed in an air-handling unit of a forced-air HVAC system.

Embodiment 25 is the method of embodiment 23 wherein the air-filtration web or the air-filtration article is installed in a room-air purifier.

Embodiment 26 is the method of any of embodiments 23-25 wherein the method achieves a Quality Factor of at least 2.0 when tested with NaCl at 32 liters per minute (LPM) and/or when tested with DOP at 32 liters per minute (LPM).

### EXAMPLES

### Test Methods

### Gurley Stiffness

Gurley Stiffness may be determined using a Model 4171E GURLEY Bending Resistance Tester from Gurley Precision Instruments. Rectangular 3.8 cm×5.1 cm samples are die cut from the webs with the sample long side aligned with the web transverse (cross-web) direction. The samples are loaded into the Bending Resistance Tester with the sample long side in the web holding clamp. The samples are flexed in both directions, viz., with the test arm pressed against the first major sample face and then against the second major sample face, and the average of the two measurements is recorded as the stiffness in milligrams. The test is treated as a destructive test and if further measurements are needed fresh samples are employed.

### Percent Penetration, Pressure Drop and the Filtration Quality Factor

Percent Penetration, Pressure Drop and the filtration Quality Factor may be determined using a challenge aerosol containing NaCl or DOP particles, delivered (unless otherwise indicated) at a flowrate of 32 liters/min, using a TSI™ Model 8130 or Model 8127 high-speed automated filter tester (commercially available from TSI Inc.). In some instances, testing may be performed at a flowrate of 85 liters/minute, as noted. The results that are recorded are initial values (e.g. initial Percent Penetration, initial Quality Factor and so on, as will be well understood by those of skill in the art), unless noted.

When testing with NaCl, particles, the particles will be generated at a mass mean diameter of approximately 0.26 μm (count median diameter of approximately 0.075 μm), according to the TSI CERTITEST Automated Filter Testers Model 8130 data sheet. For NaCl testing, the Automated Filter Tester may be operated with both the heater and particle neutralizer on. When testing with DOP particles, the particles will be generated at a mass mean diameter of approximately 0.33 μm (count median diameter of approximately 0.20 μm), according to the TSI CERTITEST Automated Filter Testers Model 8130 data sheet. (In the specific test protocol used herein, the count media diameter is targeted to 0.185 μm.) For DOP testing, the Automated Filter Tester may be operated with the heater off and the particle neutralizer on. The Percent Penetration and Quality Factor will typically differ between NaCl and DOP measurement; Pressure Drop will typically be similar for both cases.

Calibrated photometers may be employed at the filter inlet and outlet to measure the particle concentration and the % particle penetration through the filter. An MKS pressure transducer (commercially available from MKS Instruments) may be employed to measure pressure drop (ΔP, mm H₂O) through the filter. The equation:

$$QF = \frac{- ln ( \frac{\% Particle Penetration}{100} )}{Δ P}$$

may be used to calculate QF. The initial Quality Factor QF value usually provides a reliable indicator of overall performance, with higher initial QF values indicating better filtration performance and lower initial QF values indicating reduced filtration performance. Units of QF are inverse pressure drop (reported in 1/mm H₂O).

All of the above parameters were tested on filter media samples in flat-web (unpleated) form, as were the Media CCM and Pore Size Distribution characterizations described below. Pressure Drop is reported in mm H₂O; Percent Penetration is reported in percent. QF is reported in 1/mm H₂O as noted above.

### Solidity

Solidity is determined by dividing the measured bulk density of a fibrous web by the density of the materials making up the solid portion of the web. Bulk density of a web can be determined by first measuring the weight (e.g. of a 10-cm-by-10-cm section) of a web. Dividing the measured weight of the web by the web area provides the basis weight of the web, which is reported in g/m². Thickness of the web can be measured by obtaining (e.g., by die cutting) a 135 mm diameter disk of the web and measuring the web thickness with a 230 g weight of 100 mm diameter centered atop the web. The bulk density of the web is determined by dividing the basis weight of the web by the thickness of the web and is reported as g/m³.

The solidity is then determined by dividing the bulk density of the web by the density of the material (e.g. polymer) comprising the solid fibers of the web. The density of a polymer can be measured by standard means if the supplier does not specify material density. Solidity is a dimensionless fraction which is usually reported in percentage. Loft is 100 minus solidity.

### Actual Fiber Diameter (AFD)

The Actual Fiber Diameter (AFD) of fibers in a web is evaluated by imaging the web via a Phenom Pure SEM scanning electron microscope at 500 times or greater magnification and utilizing a Fibermatic image analysis program (part of Phenom Pro-Suite). At least 100 individual diameter measurements are obtained for each web sample and the mean of these measurements is reported as the AFD for that web. Bundled, twinned, and married fiber segments are attempted to be excluded from the measurements.

### Media CCM

Media CCM tests are performed to understand and compare the effect of cigarette smoke loading on particle capture, using methods similar to those of the GB/T 18801-2015 China National Standard (which tests the cumulate clean mass (CCM) performance of complete air purifier devices and filters) but that are focused on evaluating the filter media rather than on the total performance of a device.

In the Media CCM experiment, a 5.25-inch (13.3 cm) diameter circle of filter media is prepared (e.g. by die-cutting) and placed in a holder which leaves a 4.5 inch (11.4 cm) diameter circle of media exposed. The holder is placed inside a test chamber so that the test chamber is divided into two portions with the filter media sample being the only internal pathway therebetween.

A sample in the form of a cigarette or section thereof, with the filter removed, is burned inside one portion of the test chamber. During this process a fan is operating, which evacuates air from one portion of the test chamber and sends the air through an external conduit that leads to the other portion of the test chamber. The fan thus continually recirculates the air, pulling the smoke-laden air through the filter media sample. The fan is run continuously until the smoke appears (by visual observation) to be fully removed from the chamber. The test is then continued with a new cigarette sample, which process is repeated until the test is complete.

The ability of the filter media to capture particles is monitored at various steps of the cigarette smoke loading process (including an initial value, prior to exposure to cigarette smoke), by testing the Capture Efficiency (i.e., 100 minus Percent Penetration, reported in percent) of the filter media. The Capture Efficiency is tested with a TSI 8130 Automated Filter Tester using a NaCl aerosol at 85 liters per minute (face velocity of 14 cm/s).

A second order polynomial regression equation is applied to the cigarette quantity versus Capture Efficiency data to determine the point at which the Capture Efficiency has dropped to 50% of its initial value, consistent with the general approach of the GB/T Standard. The output of this test is referred to as the Media CCM Test, and is normalized to filter media area. In other words, the test results are presented in terms of the total number of cigarettes (per square meter of filter media area) that are required to cause the Capture Efficiency to drop by half.

The Media CCM test as disclosed herein was performed with standard Reference Cigarettes obtained from the University of Kentucky under the trade designation University of Kentucky, Tobacco-Health Research, Research Cigarettes type 1R4F. As is evident from Table 1, testing done with commercially available cigarettes (CAMEL brand cigarettes available from the R.J. Reynolds Tobacco Company) indicated that the results with both types of cigarettes closely paralleled each other. It is thus expected that testing with the most recent version of the University of Kentucky Research Cigarettes (Type 1R6F) would have similar results.

### Pore Size Characterization

Pore size distributions of the nonwoven samples were evaluated using an Automated Perm Porometer, Model No. APP-1200-AEX, obtained from Porous Materials Inc. (PMI), Ithaca, N.Y. The equipment software was Capwin, Version 6.71.54, the 32-bit version for Windows 95 and higher. The pore size characterizations are based on the test methods outlined in ASTM F316-03.

The testing is based on capillary flow porometry, which uses an intrusion (wetting) liquid to spontaneously fill the pores of a nonwoven sample. One side of the sample is then pressurized with a non-reacting gas (typically, filtered house compressed air). The gas pressure is gradually increased until the liquid begins to be ejected from the pores (with this occurring from the largest pores first). The process is continued until liquid has been ejected from all the pores and the entire pore size range has been characterized. During this process, the presence of pores is detected by sensing an increase in flow rate of the gas at a given applied differential pressure due to emptying of pores at that applied pressure.

It was found that nonwoven samples of the type described herein (in contrast to e.g. conventional porous membranes) required care to be taken when choosing the sample size and test parameter settings due to the nature of the material. The tests were performed using a 25 mm diameter sample size, at Maximum Pressure, with Parameter File settings as specified in the PMI Manual for the Automated Perm

Porometer. (Those skilled in porometry may choose to modify these settings slightly if needed, in accordance with e.g. the recommended “lower” pulsewidth or v2incr settings as referenced on Page A-22 of the PMI Manual under the subheading “High Flow/Low Pressure Tests”.)

In performing such testing, it was found that certain wetting liquids (of which a variety are available, at various surface tensions), in particular isopropyl alcohol and some fluorinated wetting liquids, exhibited a tendency to begin evaporating from the web sample before the wetting liquid was ejected from the last of the pores under the increased pressure of the pressurizing gas. It is known that, at least in some instances, evaporation of the wetting liquid can compromise the accuracy of the results. In performing extensive testing, it was found that the wetting liquid available from PMI under the trade name SILWICK seemed to not be as susceptible to this phenomenon. And, although SILWICK did have a somewhat higher surface tension (20.1 dynes/cm) than e.g. some fluorinated wetting liquids, SILWICK appeared to satisfactorily wet the spunbonded webs that were studied. Therefore, SILWICK was used as the wetting liquid in all such pore size characterizations. It is thus noted that although the test procedures as outlined in ASTM F316-03 were generally followed as noted above, a different wetting liquid (i.e., SILWICK) was used.

To perform the testing, samples were die cut as 25 mm diameter circles and installed in the porometer using the small-sample adapter plates. The lower adapter plate was installed in the exterior sample chamber followed, in order, by: the sample, the small o-ring, upper adapter plate, spacing insert, and the cap of the sample chamber. Finally, the sample chamber was connected to the body of the porometer via the quick-connect coupler with attached braided (air) hose.

All samples were tested using the Dry-up/Wet-up measurement technique (available under the Test Selection section of the Capillary Flow Porometer menu) which, according to the PMI Manual (page A-16), “Note 1: Dry-up/Wet-up, is the most commonly used and usually the most reliable of the five modes”. For the Dry-up/Wet-up test, the sample was placed, dry, into the sample chamber and the test was started. After the Dry-up phase completed, the software prompted the operator to “insert the saturated sample”. At this time the sample chamber was reopened, the sample was wetted with the chosen wetting fluid, was placed back into the chamber per the aforementioned practice, and the radio button clicked “okay” in order to continue the Wet-up phase of the test.

Nine (9) repeats of each sample were tested (each repeat was a different 25 mm test sample rather than the same physical sample being re-measured nine times). For each test, the reported maximum pore size (Max; corresponding to the “bubble point”), the mean flow pore size (MFPS), and the minimum pore size (Min) were recorded via the “Distribution Summary” option under the Report-Execute Report section of the Capwin software program. The Distribution Summary report calculated the mean (the average, over the nine individual tests) of each of the Min, MFPS, and Max. The Pore Size Range for each set of samples was then calculated by subtracting the average Min from the average Max. Finally, by taking the average of the Mean Flow Pore Size and dividing it by the Pore Size Range, the “MFPS/Range” ratio (as presented in bold in Table 1) was calculated and reported.

### Working Examples

### Working Example 1 (WE-1)

Using a meltspinning/spunbonding apparatus of the general type shown in FIGS. 1 and 2, monocomponent meltspun/spunbonded webs were formed from polypropylene. The extrusion head (die) had 18 rows of orifices in the machine direction, each row having 60 orifices spaced along the lateral axis of the extrusion head, for a total of 1080 orifices. The 18 rows were divided into two blocks of 9 rows separated (along the fore-aft direction of the extrusion head) by a 67 mm gap in the center of the die. The orifices were arranged in a rectangular pattern with 2.7 mm spacing in the machine direction and 7.0 mm in the cross-direction. The total width of the bank of orifices in the machine (fore-aft) direction was 11.0 cm (from the center of the first orifice to the center of the last orifice); the total length of the bank of orifices in the lateral (cross-web) direction was 41.3 cm (from the center of the first orifice to the center of the last orifice).

The polypropylene that was used had a melt flow rate index of 23 and was obtained from Total Petrochemicals under the trade designation 3766. 1.0 wt. % of CHIMASSORB 944 (Ciba Specialty Chemicals) was included to serve as a charging additive. (Typically, any such charging additive is pre-compounded with polypropylene to provide a concentrate which is then added to the extruder in the proper amount to arrive at the desired wt. % of charging additive.) The flowrate of molten polymer was approximately 0.035 grams per orifice per minute, at an extrusion temperature of 245° C.

An exhaust air setup of the general type depicted in FIG. 1 was used. Two exhaust devices bracketed the extrusion head fore and aft; the air inlet of each device extended in a lateral direction along at least the total length of the orifice bank of the extrusion head and was approximately 5 cm in height. The air in the neighborhood of the extrusion head was removed through these devices at a velocity of approximately 1 m/s.

A quenching air setup of the general type depicted in FIG. 1 was used. Two opposed quenching air-delivery devices bracketed (in the fore-aft direction) an upper portion of the stream of extruded filaments. The working face of the outlet of each air-delivery device was approximately 82 cm in lateral length (thus, each outlet was approximately twice as long as the 41 cm bank of orifices) with a working height of approximately 32 cm. The upper edge of the working face of the outlet was positioned roughly even with (i.e. within 1-2 cm of) the orifice-comprising bottom surface of the extrusion head.

Each upper quenching air-delivery device was set up in the general manner depicted in FIG. 3. The outlet of the air-delivery device was positioned approximately 5.25 inches (13.3 cm) from the centerline of the filament stream (at this position, the filament stream was approximately 11 cm wide in the fore-after direction; thus it was estimated that the outlet of each air-delivery device was approximately 3 inches (8 cm) from the closest filaments to the outlet). A primary airflow-smoothing entity in the form of a metal mesh screen (325×325 mesh; nominal wire diameter of 0.0014 inch; percent open area of 31) was positioned at the outlet; the major plane of the mesh screen was oriented parallel to the lateral axis of the extrusion head.

The air-delivery device comprised a final, straight portion (of the general type depicted in FIG. 3, and ending in the above-described outlet) that was approximately 21 inches (53 cm) in length. Over the straight portion, the cross-sectional area of the device (duct) changed in dimension and cross-sectional shape from a 12-inch (30.5 cm) diameter cylinder (of the general type denoted as item 47 in FIG. 3) to the above-described final size at the outlet. Four secondary airflow-smoothing entities were provided, spaced in series along the straight portion of the device. All four took the form of metal mesh screens (160×160 mesh; nominal wire diameter of 0.0038 inch; percent open area of 37). Their locations were, from the centerline of the filament stream: 11.4 inches (29.0 cm), 15.7 inches (39.9 cm), 18.6 inches (47.2 cm), and 26.5 inches (67.30 cm) (noting that the primary screen was located 5.25 inches (13.3 cm) from this centerline). The final section of the straight portion of the duct (i.e., the portion between the last secondary screen 43 and the primary screen 42 as shown in FIG. 4) had a constant cross-sectional area; this final section was approximately 6 inches (15 cm) in length.

A second set of quenching air-delivery devices were present, located below the above-described air-delivery devices and of similar dimensions; however, this lower set of air-delivery devices was not operated (i.e., zero airflow).

The above-described upper quenching air-delivery devices were used to supply quench air at a temperature of 13° C. (for Working Examples 1-4 and 7-8, this temperature was measured close to the outlet of the air-delivery device) and at an approximate face velocity of 0.7 m/sec. The face velocity was extremely uniform over the lateral and vertical extent of the outlet of the air-delivery device.

In some of the Working Examples that follow, the quenching air-delivery devices (and/or the exhaust air devices) were set up in modified versions of the above-described arrangements. In some Working Examples that follow, some differences in the setup are highlighted. However, it is believed that those arrangements still functioned in similar manner to the above, therefore the setup for these additional Working Examples is not described in as much detail as the above. It will be appreciated from the above descriptions that the above setup and all such setups were in an “open” configuration rather than the meltspinning apparatus being enclosed within shrouds or the like to operate in a “closed” condition.

The filaments, after passing vertically downward through the upper, active quench air-delivery devices and the lower, inactive air-delivery devices, passed downward (through a space of approximately 18 cm in height) into a movable-wall attenuator of the general type described in U.S. Pat. Nos. 6,607,624 and 6,916,752 was employed. The attenuator was operated using an air knife gap of 0.51 mm, air fed to the air knife at a pressure of 21 kPa, an attenuator top gap width of 5.8 mm, an attenuator bottom gap width of 5.6 mm, an attenuation chamber length of 15 cm, and an open width in the lateral direction of 52 cm. The distance from the extrusion head to the outlet of the air knife of the attenuator (i.e., position 28a of FIG. 2) was 100 cm, and the distance from the attenuator air knife outlet to the collection belt was 76 cm. The distance from the bottom of the attenuator to the collection belt was 61 cm. The meltspun fiber stream was deposited on the collection belt at a width of about 60 cm with a vacuum established under the collection belt of approximately 3 kPa. The collection belt was made from 9-mesh stainless steel and moved at a velocity of 0.013 m/s.

The mass of collected meltspun fibers (web), as carried on the belt, was then passed underneath a controlled-heating bonding device to autogenously bond at least some of the fibers together. Air was supplied through the bonding device at a velocity of approximately 11 m/sec at the outlet slot, which was 38 mm in the machine direction. The air outlet was about 25 mm from the collected web as the web passed underneath the bonding device. The temperature of the air passing through the slot of the controlled heating device was approximately 156° C. as measured at the entry point for the heated air into the housing. Ambient temperature air was forcibly drawn through the web after the web passed underneath the bonding device, to cool the web to approximately ambient temperature.

The web thus produced was bonded with sufficient integrity to be self-supporting and handleable using normal processes and equipment; the web could be wound by normal windup into a storage roll or could be subjected to various operations such as pleating and assembly into a filtration device such as a pleated filter panel, without requiring inclusion of a co-planar support structure such as a backing layer. This was true of all of the additional Working Examples that follow.

The web was hydrocharged with deionized water according to the techniques taught in U.S. Pat. No. 5,496,507, and dried. (All of the other working example webs were charged in similar manner.)

### Working Example 2 (WE-2)

Working Example 2 was prepared in an analogous manner as Working Example 1, except with the following differences. Polypropylene having a melt flow rate index of 32 available from ExxonMobil under the trade designation ACHIEVE ADVANCED PP1605 was used. The combined polymer and charging additive was extruded at a rate of 0.031 grams per orifice per minute. The collection belt moved at a velocity of 0.010 m/s. Air was supplied through the bonding device at a velocity of approximately 9 m/sec at the outlet slot, and at a temperature of 157° C.

### Working Example 3 (WE-3)

Working Example 3 was prepared in an analogous manner as Working Example 1, except with the following differences. The combined polymer and additive was extruded at a rate of 0.027 grams per orifice per minute. An attenuator bottom gap width of 5.3 mm was used. The collection belt moved at a velocity of 0.008 m/s. The vacuum established under the collection belt was approximately 4 kPa. The upper quench velocity was approximately 0.6 m/s. The distance from the extrusion head to the attenuator air knife outlet was 108 cm.

### Working Example 4 (WE-4)

Working Example 4 was prepared in an analogous manner as Working Example 3, except with the following differences. Polypropylene having a melt flow rate index of 32 available from ExxonMobil under the trade designation ACHIEVE ADVANCED PP1605 was used.

### Working Example 5 (WE-5)

Working Example 5 was prepared in an analogous manner as Working Example 1, except with the following differences. The distance from the extrusion head to the attenuator air knife outlet was 104 cm. The extrusion temperature was 245° C., and the combined polymer and additive was extruded at a rate of 0.031 grams per orifice per minute. The collection belt moved at a velocity of 0.010 m/s. The vacuum established under the collection belt was approximately 4 kPa. Air was supplied through the bonding device at a temperature of 157° C. The upper quench air velocity was approximately 0.9 m/sec, and the quench air temperature was set to a nominal set point of 17° C. (For Working Examples 5, 6 and 9, the nominal set point of the chiller that was used to cool the air was recorded.)

Two exhaust devices bracketed the extrusion head; the air inlet of each device extended in a lateral direction along at least the total length of the orifice bank of the extrusion head and was approximately 2.5 cm in height. The exhaust air velocity was not recorded.

A modified upper quenching air setup was used. The setup still relied on two opposed quenching air-delivery devices that bracketed (in the fore-aft direction) an upper portion of the stream of extruded filaments. The working face of the outlet of each air-delivery device was approximately 55 cm in lateral length with a working height of approximately 30 cm. The exhaust devices were positioned atop the quenching air-delivery devices with the upper edge of the exhaust devices being positioned roughly even with (i.e. within 1-2 cm of) the orifice-comprising bottom surface of the extrusion head.

The outlet of each air-delivery device was positioned approximately 5.0 inches (13 cm) from the centerline of the filament stream. A primary airflow-smoothing entity in the form of a metal mesh screen (325×325 mesh; nominal wire diameter of 0.0014 inch, percent open area of 31) was positioned at the outlet; the major plane of the mesh screen was oriented parallel to the lateral axis of the extrusion head.

The air-delivery device was comprised a final, straight portion (ending in the above-described outlet) that was approximately 21 inches (53 cm) in length. Over this straight portion, the cross-sectional area of the device (duct) did not expand significantly. A secondary airflow-smoothing entity was provided at a location partway along this straight portion (approximately 3.4 inches (8.6 cm) rearward (upstream) of the primary airflow-smoothing entity. This secondary airflow-smoothing entity was a 325×325 mesh screen substantially similar to the first airflow-smoothing entity, and oriented similarly. Another secondary airflow-smoothing entity was provided at a point further upstream (approximately 8.0 inches (20 cm) rearward of the second 325×325 mesh screen). This entity was a perforated metal plate comprising 0.125 inch (0.32 cm) diameter holes that provided a percent open area of 40.

### Working Example 6 (WE-6)

Working Example 6 was prepared in an analogous manner as Working Example 5, except with the following differences. Polypropylene having a melt flow rate index of 32 available from ExxonMobil under the trade designation Achieve™ Advanced PP1605 was used. The collection belt moved at a velocity of 0.009 m/s.

### Working Example 7 (WE-7)

Working Example 7 was prepared in an analogous manner as Working Example 1, except with the following differences. Polypropylene having a melt flow rate index of 100 available from Total Petrochemicals under the trade designation 3860X was used. The distance from the extrusion head to the attenuator air knife outlet was 100 cm, and the distance from the attenuator air knife outlet to the collection belt was 66 cm. The extrusion temperature was 240° C., and the combined polymer and additive was extruded at a rate of 0.107 grams per orifice per minute. The collection belt moved at a velocity of 0.010 m/s. Air was fed to the air knife at a pressure of 55 kPa. The meltspun fiber stream was deposited on the collection belt at a width of about 50 cm with a vacuum established under the collection belt of approximately 2 kPa. The collection belt moved at a velocity of 0.042 m/s. Air was supplied through the bonding device at a temperature of 154° C.

In this Working Example, the lower quench air-delivery devices were active; air was supplied at an approximate face velocity of 0.2 m/sec and a temperature of 13° C. In this instance the lower quench air-delivery devices were operated mainly to enhance the steering of the filaments into the attenuator. Some additional quenching may have been achieved by the lower quench air-delivery devices, but it is believed that this may have been rather small in comparison to the quenching effect achieved by the upper quench-air delivery devices.

### Working Example 8 (WE-8)

Working Example 8 was prepared in an analogous manner as Working Example 1, except with the following differences. The distance from the extrusion head to the attenuator air knife outlet was 128 cm, and the distance from the attenuator air knife outlet to the collection belt was 71 cm. The extrusion head had 26 rows of 60 orifices each, with the orifice to orifice spacing as Working Example 1, split into two blocks of 13 rows separated by a 119 mm gap in the middle of the die, making a total of 1560 orifices. The combined polymer and additive was extruded at a rate of 0.072 grams per orifice per minute. A different movable-wall attenuator, but one that was also generally similar to that shown in U.S. Pat. Nos. 6,607,624 and 6,916,752, was employed, with an attenuator top gap width of 7.9 mm, an attenuator bottom gap width of 7.4 mm, and an attenuation chamber length of 14 cm. The collection belt moved at a velocity of 0.037 m/s. The vacuum established under the collection belt was approximately 4 kPa, and the web width was approximately 53 cm. The upper quench air temperature was 10° C. Air was supplied to the lower quench boxes (air-delivery devices) at an approximate face velocity of 0.4 m/sec and a temperature of 10° C. Air was supplied through the bonding device at 8 m/sec at the outlet slot, which extended 76 mm in the machine direction. Air was supplied through the bonding device at a temperature of 154° C.

### Working Example 9 (WE-9)

Working Example 9 was prepared in an analogous manner as Working Example 7, except with the following differences. The distance from the extrusion head to the attenuator air knife outlet was 109 cm, and the distance from the attenuator to the collection belt was 69 cm. The extrusion head had 26 rows of 60 orifices each, with the orifice to orifice spacing as Working Example 1, split into two blocks of 13 rows separated by a 119 mm gap in the middle of the die, making a total of 1560 orifices. The combined polymer and additive was extruded at a rate of 0.083 grams per orifice per minute. A different movable-wall attenuator, but one that was also similar to that shown in U.S. Pat. Nos. 6,607,624 and 6,916,752, was employed, with an attenuator top gap width of 8.1 mm, an attenuator bottom gap width of 7.1 mm, and an attenuation chamber length of 14 cm. The collection belt moved at a velocity of 0.039 m/s. The vacuum established under the collection belt was not measured. The air outlet of the bonding device was about 38 mm from the collected web. A modified upper quenching air setup was used of the type described above in Working Example 5. The top quench air velocity was approximately 1.2 m/sec, and the top quench air temperature was set to 17° C. Air was supplied to the lower quench boxes at an approximate face velocity of 0.2 m/sec and a temperature of 17° C. The outlet of each quench boxes had 30 cm of open airflow (working face) in the vertical dimension, and the open width of the working face was 55 cm in the cross-direction. Two exhaust air streams 25 mm in height were used; exhaust velocity was not measured. Air was supplied through the bonding device at a temperature of 154° C.

### Comparative Examples

### Comparative Example 1 (CE-1)

Comparative Example 1 is a meltspun, charged, pleatable spunbonded air-filtration web of a type commonly used in air filters for intermediate-performance (non-HEPA) room air purifiers. The web is comprised of monocomponent polypropylene fibers (also comprising a charging additive), and was made using conventional meltspinning (in particular, quenching) methods, i.e. not using the special methods disclosed herein.

### Comparative Example 2 (CE-2)

Comparative Example 2 is the meltspun, spunbonded air-filtration web disclosed in Example 3 of U.S. Pat. No. 7,947,142, which is incorporated by reference herein for this purpose. The web is comprised of monocomponent polypropylene fibers (also comprising a charging additive) as described in the '142 patent. The web was made using conventional meltspinning methods as described in the '142 patent, i.e. not using the special methods disclosed herein. The entries listed in Table 1 herein for Comparative Example 2 are the exact data for this web as disclosed in Table 3A of the '142 patent.

### Comparative Example 2ᵣ (CE-2ᵣ)

Comparative Example 2ᵣ contains data that was obtained from a historical (retain) sample of the air-filtration web of Example 3 of the '142 patent. This sample was available since certain inventors on the present application were also inventors on the '142 patent and had stored (uncharged) physical samples in archive. This retain sample was used in order to evaluate particular properties (e.g., pore size characteristics) that had not been tested in the '142 patent, for purposes of comparison to the above-presented Working Examples. (It is emphasized that not only were pore size properties not presented in the '142 patent, they were not evaluated, there being at the time no appreciation of the role of such properties as now revealed in the present work.)

It was found that the retain sample would not satisfactorily hold a charge due to the age of the sample (this is a phenomenon that has been often seen with aged samples). Therefore, actual filtration performance (e.g. Percent Penetration, Quality Factor and CCM) was not tested on the aged sample. However, it was believed that the arrangement of the fibers to provide interstitial spaces, as characterized by the above-described porometry methods, would have changed little if at all. The data listed in Table 1 for Comparative Example 2ᵣ is thus data obtained from recent testing of this retain sample.

### Reference Examples

In order to serve as a baseline for characterizing high-efficiency filtration performance, two Reference Examples were obtained. Both of these webs were meltblown webs (i.e., blown-microfiber (BMF) webs) of a type commonly used in high performance air filters for e.g. room air purifiers or clean rooms. Both webs were comprised of monocomponent polypropylene fibers (also comprising a charging additive). Each web was obtained as a stand-alone BMF layer, and was extremely weak and flimsy (Gurley stiffness in the range of 20-60) as is typical of BMF webs. Such webs are not pleatable, and for actual commercial use in air filters the webs are typically disposed on support webs to allow them to be successfully pleated. (Such support webs are often conventional spunbonded webs that have little effect on the filtration performance of the BMF web other than that imparted by the pleating.) For the present testing, the BMF webs were obtained as stand-alone layers as noted.

One such web was a HEPA-performing filtration web as defined herein (Capture Efficiency of 99.97 or greater). The web was of the general type used (after being disposed on a support web) in the Filtrete Advanced Allergen, Bacteria & Virus Filter for room air purifiers (sold by 3M Company).

The other was a high-efficiency filtration web (Percent Penetration 0.037, corresponding to a Capture Efficiency of 99.963) but did not quite achieve HEPA-filtration performance. The web was of the general type used (after being disposed on a support web) in the KJEA4187 room air purifier (sold by 3M China).

The salient characteristic of these filtration webs was that (in addition to being weak and unpleatable) they both exhibited an Actual Fiber Diameter of less than 3.0 μm (2.7 μm and 2.9 μm, respectively).

### Testing and Evaluation

Various geometric/physical properties and pore size characteristics of the Working Examples and the Comparative Examples are presented in Table 1. The units for the various parameters are as follows: Basis Weight—grams per square meter (gsm); Thickness—mils; Solidity—%; Gurley Stiffness—milligrams; Actual Fiber Diameter (AFD)—microns. Mean Flow Pore Size, Max Pore Size, Min Pore Size, and Pore Size Range—all in microns. Mean Flow Pore Size/Pore Size Range ratio (“MFPS/Range”)—dimensionless.

Various air filtration performance parameters of the Working Examples and the Comparative Examples are also presented in Table 1. The units for these are as follows. Pressure Drop at 85 liters per minute (PD, 85 lpm), and Pressure Drop at 32 liters per minute (PD, 32 lpm)—both in mm H₂0. Percent Penetration, NaCl, 85 liters per minute (% Pen NaCl 85 lm); Percent Penetration, NaCl, 32 liters per minute (% Pen NaCl 32 lpm); Percent Penetration, DOP, 85 liters per minute (% Pen DOP 85 lpm); and Percent Penetration, DOP, 32 liters per minute (% Pen DOP 32 lpm)—all in percent. Quality Factor, NaCl, 85 lpm (QF NaCl 85 lpm); Quality Factor, NaCl, 32 lpm (QF NaCl 32 lpm); Quality Factor, DOP, 85 lpm (QF DOP 85 lpm); Quality Factor, DOP, 32 lpm (QF DOP 32 lpm)—all in 1/mm H₂O. Media CCM with Research Cigarettes (CCM Research) and Media CCM with CAMEL brand cigarettes (CCM CAMEL)—both in number of cigarettes per square meter of filter area.

TABLE 1

| | WE-1 | WE-2 | WE-3 | WE-4 | WE-5 | WE-6 | WE-7 | WE-8 | WE-9 | CE-1 | CE-2 | CE-2ᵣ |
|---|---|---|---|---|---|---|---|---|---|---|---|---|
| Basis Weight | 110 | 119 | 125 | 117 | 116 | 119 | 123 | 120 | 124 | 104 | 152 | 150 |
| Thickness | 32 | 35 | 43 | 34 | 40 | 41 | 43 | 42 | 45 | 38 | 44 | 47 |
| Solidity | 15.0 | 14.7 | 12.6 | 14.9 | 12.6 | 12.6 | 12.4 | 12.3 | 12.0 | 11.8 | 15.2 | 13.9 |
| Gurley | 1180 | 1350 | 1460 | 1290 | 1240 | 1280 | 1050 | 1040 | | 915 | 4560 | 2180 |
| Stiffness | | | | | | | | | | | | |
| Actual Fiber | 7.5 | 7.0 | 6.2 | 5.4 | 6.6 | 6.8 | 9.6 | 11.3 | 9.7 | 14.6 | | 9.7 |
| Diameter | | | | | | | | | | | | |
| Min Pore | 9.4 | 9.1 | 7.9 | 10.1 | 10.4 | 9.6 | 15.6 | 19.0 | 11.5 | 7.7 | | 3.3 |
| Size | | | | | | | | | | | | |
| Mean Flow | 12.5 | 12.3 | 11.3 | 12.4 | 13.5 | 12.3 | 21.2 | 23.4 | 20.1 | 29.7 | | 15.7 |
| Pore Size | | | | | | | | | | | | |
| Max Pore | 23.5 | 23.2 | 21.4 | 23.4 | 26.7 | 23.1 | 44.4 | 45.0 | 43.0 | 68.5 | | 34.4 |
| Size | | | | | | | | | | | | |
| Pore Size | 14.0 | 14.1 | 13.5 | 13.4 | 16.2 | 13.5 | 28.8 | 26.0 | 31.6 | 60.8 | | 31.0 |
| Range | | | | | | | | | | | | |
| MFPS/Range | 0.89 | 0.87 | 0.83 | 0.93 | 0.83 | 0.91 | 0.73 | 0.90 | 0.64 | 0.49 | | 0.51 |
| PD, | 15.2 | 16.5 | 19.0 | 20.4 | 15.5 | 15.5 | 6.2 | 6.0 | 5.8 | 2.9 | 10 | 10.6 |
| 85 lpm | | | | | | | | | | | | |
| PD, | 5.6 | 6.0 | 7.2 | 7.6 | 5.7 | 6.4 | 2.2 | 2.2 | 2.0 | 1.0 | | |
| 32 lpm | | | | | | | | | | | | |
| %Pen, NaCl | 0.10 | 0.12 | 0.017 | 0.043 | 0.070 | 0.070 | 2.7 | 0.48 | 0.80 | 7.0 | | |
| 85 lpm | | | | | | | | | | | | |
| QF, NaCl | 0.45 | 0.41 | 0.46 | 0.38 | 0.47 | 0.47 | 0.58 | 0.89 | 0.84 | 0.92 | | |
| 85 lpm | | | | | | | | | | | | |
| % Pen, NaCl | 0.006 | 0.008 | 0.002 | 0.003 | 0.005 | 0.005 | 0.44 | 0.051 | | 2.05 | | |
| 32 lpm | | | | | | | | | | | | |
| QF, NaCl | 1.74 | 1.57 | 1.51 | 1.38 | 1.73 | 1.54 | 2.52 | 3.46 | | 3.98 | | |
| 32 lpm | | | | | | | | | | | | |
| % Pen, DOP | 0.43 | 0.31 | 0.13 | 0.16 | | | 5.8 | 1.76 | 2.06 | 12.7 | 2.7 | |
| 85 lpm | | | | | | | | | | | | |
| QF, DOP | 0.36 | 0.35 | 0.35 | 0.32 | | | 0.46 | 0.67 | 0.67 | 0.71 | 0.34 | |
| 85 lpm | | | | | | | | | | | | |
| % Pen, DOP | 0.027 | 0.019 | 0.003 | 0.008 | 0.025 | 0.008 | 1.51 | 0.13 | 0.28 | 4.6 | | |
| 32 lpm | | | | | | | | | | | | |
| QF, DOP | 1.47 | 1.43 | 1.46 | 1.25 | 1.46 | 1.48 | 1.95 | 3.05 | 2.98 | 3.16 | | |
| 32 lpm | | | | | | | | | | | | |
| CCM Research | 557 | 546 | 1050 | 888 | | | 162 | 194 | | 80 | | |
| CCM | 595 | 558 | 1080 | 898 | 512 | 696 | 161 | 207 | 176 | 73 | | |
| Camel | | | | | | | | | | | | |

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A spunbonded air-filtration web comprising meltspun autogenously bonded electret fibers with an Actual Fiber Diameter of from 3.0 microns to 15 microns, wherein the web exhibits a ratio of mean flow pore size to pore size range of from 0.55 to 2.5.

2. The air-filtration web of claim 1 wherein the web exhibits a solidity of from greater than 8.0% to 18.0%, a basis weight of from 60 to 200 grams per square meter, and a Gurley stiffness of at least 500.

3. The air-filtration web of claim 1 wherein the meltspun autogenously bonded electret fibers are monocomponent fibers.

4. The air-filtration web of claim 1 wherein the web comprises meltspun autogenously bonded electret fibers with an Actual Fiber Diameter of from greater than 8.0 microns, to 12.0 microns.

5. The air-filtration web of claim 1 wherein the web is at least substantially free of nanofibers.

6. The air-filtration web of claim 1 wherein the web exhibits a ratio of mean flow pore size to pore size range of from 0.60 to 1.0.

7. The air-filtration web of claim 1 wherein the web exhibits a solidity of from 9.0% to 16%.

8. The air-filtration web of claim 1 wherein the web exhibits a basis weight of from 80 to 140 grams per square meter.

9. The air-filtration web of claim 1 wherein the web exhibits a Gurley stiffness of at least 800.

10. The air-filtration web of claim 1 wherein the web exhibits a pressure drop of less than 10 mm H₂O when tested at 85 liters per minute (LPM).

11. The air-filtration web of claim 1 wherein the web exhibits a Quality Factor of at least about 1.50 l/mm H₂O, when tested with NaCl at 32 liters per minute (LPM).

12. The air-filtration web of claim 1 wherein the web exhibits a Quality Factor of at least about 2.0 l/mm H₂O when tested with NaCl at 32 liters per minute (LPM).

13. The air-filtration web of claim 1 wherein the web exhibits a Capture Efficiency of at least 99 percent when tested with NaCl at 32 liters per minute (LPM).

14. The air-filtration web of claim 1 wherein the web exhibits a Media CCM of greater than 150 Reference Cigarettes per square meter of web area.

15. The air-filtration web of claim 1 wherein the web is at least substantially free of meltblown fibers.

16. An air-filtration article comprising the spunbonded air-filtration web of claim 1, wherein the spunbonded air-filtration web is the only air-filtration layer of the air-filtration article.

17. The air-filtration web of claim 1 wherein the web is pleated to comprise rows of oppositely-facing pleats.

18. A method of filtering at least particles from a moving airstream, the method comprising passing the moving airstream through the air-filtration web of claim 1.

19. The method of claim 18 wherein the air-filtration web is installed in an air-handling unit of a forced-air HVAC system.

20. The method of claim 18 wherein the air-filtration web is installed in a room-air purifier.

21. The method of claim 18 wherein the method achieves a Quality Factor of at least 2.0 when tested with NaCl at 32 liters per minute (LPM).
